(19) United States
(12) Patent Application Publication
(10) Pub. No.: US 2025/0084324 A1
(43) Pub. Date: Mar. 13, 2025

(54) INTEGRATED SLURRY PHASE HYDROCRACKING PROCESS TO PRODUCE CHEMICALS

(71) Applicants: Saudi Aramco Technologies Company, Dhahran (SA); Chiyoda Corporation, Nishi-ku Yokohama (JP)

(72) Inventors: Omer Refa KOSEOGLU, Dhahran (SA); Ashok PUNETHA, Dhahran (SA); Shigetaka FUJII, Nishi-ku Yokohama (JP); Satoshi MORIKAMI, Nishi-ku Yokohama (JP); Shinichi TADOKORO, Nishi-ku Yokohama (JP)

(21) Appl. No.: 18/462,609

(22) Filed: Sep. 7, 2023

(51) Int. Cl. C10G 65/12; B01D 3/10; B01D 3/14

(52) U.S. Cl. CPC C10G 65/12; B01D 3/10; B01D 3/143

(57) ABSTRACT

The present disclosure relates to methods for petrochemical production integrating a slurry phase hydrocracking process and an inline hydrotreating process. A slurry-phase hydrocracking feed comprising residue stream and/or a deasphalted residue stream is processed in a slurry-phase hydrocracking reaction zone to produce slurry-phase hydrocracking effluents. A first stream of slurry-phase hydrocracking effluents is discharged including unreacted hydrogen and which is under hydrogen partial pressure. The slurry-phase hydrocracking effluents are processed in an inline hydrotreating zone for hydrodesulfurization and/or hydrodenitrogenation to produce a hydrotreated effluent. Downstream FCC and petrochemicals production complex units are used to produce light olefins and aromatic products.

### FIELD OF THE DISCLOSURE

The present disclosure relates to methods for petrochemical production integrating a slurry phase hydrocracking process and an inline hydrotreating process.

### BACKGROUND OF THE DISCLOSURE

Crude oil originates from the decomposition and transformation of aquatic, mainly marine, living organisms and/or land plants that became buried under successive layers of mud and silt some 15-500 million years ago. They are essentially very complex mixtures of many thousands of different hydrocarbons. Depending on the source, the oil predominantly contains various proportions of straight and branched-chain paraffins, cycloparaffins, and naphthenic, aromatic, and polynuclear aromatic hydrocarbons. These hydrocarbons can be gaseous, liquid, or solid under normal conditions of temperature and pressure, depending on the number and arrangement of carbon atoms in the molecules.

Crude oils vary widely in their physical and chemical properties from one geographical region to another and from field to field. Crude oils are usually classified into three groups according to the nature of the hydrocarbons they contain: paraffinic, naphthenic, asphaltic, and their mixtures. The differences are due to the different proportions of the various molecular types and sizes. One crude oil can contain mostly paraffins, another mostly naphthenes. Whether paraffinic or naphthenic, one can contain a large quantity of lighter hydrocarbons and be mobile or contain dissolved gases; another can consist mainly of heavier hydrocarbons and be highly viscous, with little or no dissolved gas. Crude oils can also include heteroatoms containing sulfur, nitrogen, nickel, vanadium and other elements in quantities that impact the refinery processing of the crude oil fractions. Light crude oils or condensates can contain sulfur in concentrations as low as 0.01 wt % of sulfur; in contrast, heavy crude oils can contain as much as 5-6 wt %. Similarly, the nitrogen content of crude oils can range from 0.001-1.0 wt %.

### SUMMARY OF THE DISCLOSURE

In some embodiments, a crude oil feedstream is separated by atmospheric distillation into at least a first ADU fraction comprising straight run naphtha, a second ADU fraction comprising middle distillates, and a third ADU fraction comprising atmospheric residue. In a vacuum distillation unit (VDU), at least a first VDU fraction comprising vacuum gas oil, and a second VDU fraction comprising vacuum residue are separated from the third ADU fraction. All, a substantial portion, a significant portion or a major portion of the second VDU fraction is processed in a slurry-phase hydrocracking reaction zone to produce slurry-phase hydrocracking effluents. The processing in the slurry-phase hydrocracking reaction zone includes dispersing an effective amount of catalyst in the slurry-phase hydrocracking feed as a reactant-catalyst dispersion and passing an effective amount of a hydrogen-containing gas through the reactant-catalyst dispersion. Hydrocarbons in the slurry-phase hydrocracking feed are cracked into free-radical hydrocarbons of reduced size and the free-radical hydrocarbons are stabilized by hydrogen from the hydrogen-containing gas. At least a first stream of slurry-phase hydrocracking effluents is discharged including unreacted hydrogen and which is under hydrogen partial pressure, and discharging a second stream of unconverted bottoms. All, a substantial portion, a significant portion or a major portion of the slurry-phase hydrocracking effluents, all, a substantial portion, a significant portion or a major portion of the second ADU fraction, all, a substantial portion, a significant portion or a major portion of the first VDU fraction, and all or a portion of a fourth FCC fraction are processed in an inline hydrotreating zone for hydrodesulfurization and/or hydrodenitrogenation to produce a hydrotreated effluent. The hydrotreated effluent are fractionated into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons. All, a substantial portion, a significant portion or a major portion of the third cracked/hydrotreated fraction is processed in a fluidized catalytic cracking zone for catalytic cracking to produce FCC effluents and separating the FCC effluents into at least a light gas stream including hydrogen, C1 hydrocarbons and C2 hydrocarbons, a first FCC fraction comprising C3 hydrocarbons, a second FCC fraction comprising C4 hydrocarbons, a third FCC fraction comprising FCC naphtha, a fourth FCC fraction comprising light cycle oil, and a fifth FCC fraction comprising heavy cycle oil and/or FCC slurry oil. All, a substantial portion, a significant portion or a major portion of each of the first cracked/hydrotreated fraction, the second cracked/hydrotreated fraction, the first FCC fraction, the third FCC fraction, the first ADU fraction are processed in a petrochemicals production complex to produce light olefins and aromatic products. The first ADU fraction is optionally first subjected to a naphtha hydrotreating step before processing in the petrochemicals production complex.

In some embodiments, a crude oil feedstream is separated by atmospheric distillation into at least a first ADU fraction comprising straight run naphtha, a second ADU fraction comprising middle distillates, and a third ADU fraction comprising atmospheric residue. All, a substantial portion, a significant portion or a major portion of the third ADU fraction is processed in a slurry-phase hydrocracking reaction zone to produce slurry-phase hydrocracking effluents. The processing in the slurry-phase hydrocracking reaction zone includes dispersing an effective amount of catalyst in the slurry-phase hydrocracking feed as a reactant-catalyst dispersion and passing an effective amount of a hydrogen-containing gas through the reactant-catalyst dispersion. Hydrocarbons in the slurry-phase hydrocracking feed are cracked into free-radical hydrocarbons of reduced size and the free-radical hydrocarbons are stabilized by hydrogen from the hydrogen-containing gas. At least a first stream of slurry-phase hydrocracking effluents is discharged including unreacted hydrogen and which is under hydrogen partial pressure, and discharging a second stream of unconverted bottoms. All, a substantial portion, a significant portion or a major portion of the slurry-phase hydrocracking effluents, all, a substantial portion, a significant portion or a major portion of the second ADU fraction and all or a portion of a fourth FCC fraction are processed in an inline hydrotreating zone for hydrodesulfurization and/or hydrodenitrogenation to produce a hydrotreated effluent. The hydrotreated effluent are fractionated into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons. All, a substantial portion, a significant portion or a major portion of the third cracked/hydrotreated fraction is processed in a fluidized catalytic cracking zone for catalytic cracking to produce FCC effluents and separating the FCC effluents into at least a light gas stream including hydrogen, C1 hydrocarbons and C2 hydrocarbons, a first FCC fraction comprising C3 hydrocarbons, a second FCC fraction comprising C4 hydrocarbons, a third FCC fraction comprising FCC naphtha, a fourth FCC fraction comprising light cycle oil, and a fifth FCC fraction comprising heavy cycle oil and/or FCC slurry oil. All, a substantial portion, a significant portion or a major portion of each of the first cracked/hydrotreated fraction, the second cracked/hydrotreated fraction, the first FCC fraction, the third FCC fraction, the first ADU fraction are processed in a petrochemicals production complex to produce light olefins and aromatic products. The first ADU fraction is optionally first subjected to a naphtha hydrotreating step before processing in the petrochemicals production complex are processed in a petrochemicals production complex to produce light olefins and aromatic products.

In some embodiments, a crude oil feedstream is separated by atmospheric distillation into at least a first ADU fraction comprising straight run naphtha, a second ADU fraction comprising middle distillates, and a third ADU fraction comprising atmospheric residue. In a vacuum distillation unit (VDU), at least a first VDU fraction comprising vacuum gas oil, and a second VDU fraction comprising vacuum residue are separated from the third ADU fraction. All, a substantial portion, a significant portion or a major portion of the second VDU fraction is subjected to solvent deasphalting to produce a solvent deasphalted vacuum residue and asphalt. All, a substantial portion, a significant portion or a major portion of the solvent deasphalted vacuum residue is processed in a slurry-phase hydrocracking reaction zone to produce slurry-phase hydrocracking effluents. The processing in the slurry-phase hydrocracking reaction zone includes dispersing an effective amount of catalyst in the slurry-phase hydrocracking feed as a reactant-catalyst dispersion and passing an effective amount of a hydrogen-containing gas through the reactant-catalyst dispersion. Hydrocarbons in the slurry-phase hydrocracking feed are cracked into free-radical hydrocarbons of reduced size and the free-radical hydrocarbons are stabilized by hydrogen from the hydrogen-containing gas. At least a first stream of slurry-phase hydrocracking effluents is discharged including unreacted hydrogen and which is under hydrogen partial pressure, and discharging a second stream of unconverted bottoms. All, a substantial portion, a significant portion or a major portion of the slurry-phase hydrocracking effluents all, a substantial portion, a significant portion or a major portion of the second ADU fraction, all, a substantial portion, a significant portion or a major portion of the first VDU fraction, and all or a portion of a fourth FCC fraction are processed in an inline hydrotreating zone for hydrodesulfurization and/or hydrodenitrogenation to produce a hydrotreated effluent. The hydrotreated effluent are fractionated into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons. All, a substantial portion, a significant portion or a major portion of the third cracked/hydrotreated fraction is processed in a fluidized catalytic cracking zone for catalytic cracking to produce FCC effluents and separating the FCC effluents into at least a light gas stream including hydrogen, C1 hydrocarbons and C2 hydrocarbons, a first FCC fraction comprising C3 hydrocarbons, a second FCC fraction comprising C4 hydrocarbons, a third FCC fraction comprising FCC naphtha, a fourth FCC fraction comprising light cycle oil, and a fifth FCC fraction comprising heavy cycle oil and/or FCC slurry oil. All, a substantial portion, a significant portion or a major portion of each of the first cracked/hydrotreated fraction, the second cracked/hydrotreated fraction, the first FCC fraction, the third FCC fraction, the first ADU fraction are processed in a petrochemicals production complex to produce light olefins and aromatic products. The first ADU fraction is optionally first subjected to a naphtha hydrotreating step before processing in the petrochemicals production complex are processed in a petrochemicals production complex to produce light olefins and aromatic products.

In some embodiments, a crude oil feedstream is separated by atmospheric distillation into at least a first ADU fraction comprising straight run naphtha, a second ADU fraction comprising middle distillates, and a third ADU fraction comprising atmospheric residue. All, a substantial portion, a significant portion or a major portion of the third ADU fraction is subjected to solvent deasphalting to produce a solvent deasphalted atmospheric residue and asphalt. All, a substantial portion, a significant portion or a major portion of the solvent deasphalted atmospheric residue is processed in a slurry-phase hydrocracking reaction zone to produce slurry-phase hydrocracking effluents. The processing in the slurry-phase hydrocracking reaction zone includes dispersing an effective amount of catalyst in the slurry-phase hydrocracking feed as a reactant-catalyst dispersion and passing an effective amount of a hydrogen-containing gas through the reactant-catalyst dispersion. Hydrocarbons in the slurry-phase hydrocracking feed are cracked into free-radical hydrocarbons of reduced size and the free-radical hydrocarbons are stabilized by hydrogen from the hydrogen-containing gas. At least a first stream of slurry-phase hydrocracking effluents is discharged including unreacted hydrogen and which is under hydrogen partial pressure, and discharging a second stream of unconverted bottoms. All, a substantial portion, a significant portion or a major portion of the slurry-phase hydrocracking effluents, all, a substantial portion, a significant portion or a major portion of the second ADU fraction and all or a portion of a fourth FCC fraction are processed in an inline hydrotreating zone for hydrodesulfurization and/or hydrodenitrogenation to produce a hydrotreated effluent. The hydrotreated effluent are fractionated into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons. All, a substantial portion, a significant portion or a major portion of the third cracked/hydrotreated fraction is processed in a fluidized catalytic cracking zone for catalytic cracking to produce FCC effluents and separating the FCC effluents into at least a light gas stream including hydrogen, C1 hydrocarbons and C2 hydrocarbons, a first FCC fraction comprising C3 hydrocarbons, a second FCC fraction comprising C4 hydrocarbons, a third FCC fraction comprising FCC naphtha, a fourth FCC fraction comprising light cycle oil, and a fifth FCC fraction comprising heavy cycle oil and/or FCC slurry oil. All, a substantial portion, a significant portion or a major portion of each of the first cracked/hydrotreated fraction, the second cracked/hydrotreated fraction, the first FCC fraction, the third FCC fraction, the first ADU fraction are processed in a petrochemicals production complex to produce light olefins and aromatic products. The first ADU fraction is optionally first subjected to a naphtha hydrotreating step before processing in the petrochemicals production complex are processed in a petrochemicals production complex to produce light olefins and aromatic products.

In some embodiments, a crude oil feedstream is subjected to solvent deasphalting to produce a deasphalted crude oil stream and asphalt. The deasphalted crude oil stream is separated by atmospheric distillation into at least a first ADU fraction comprising straight run naphtha, a second ADU fraction comprising middle distillates, and a third ADU fraction comprising atmospheric residue. In a vacuum distillation unit (VDU), at least a first VDU fraction comprising vacuum gas oil, and a second VDU fraction comprising vacuum residue are separated from the third ADU fraction. All, a substantial portion, a significant portion or a major portion of the second VDU fraction is processed in a slurry-phase hydrocracking reaction zone to produce slurry-phase hydrocracking effluents. The processing in the slurry-phase hydrocracking reaction zone includes dispersing an effective amount of catalyst in the slurry-phase hydrocracking feed as a reactant-catalyst dispersion and passing an effective amount of a hydrogen-containing gas through the reactant-catalyst dispersion. Hydrocarbons in the slurry-phase hydrocracking feed are cracked into free-radical hydrocarbons of reduced size and the free-radical hydrocarbons are stabilized by hydrogen from the hydrogen-containing gas. At least a first stream of slurry-phase hydrocracking effluents is discharged including unreacted hydrogen and which is under hydrogen partial pressure, and discharging a second stream of unconverted bottoms. All, a substantial portion, a significant portion or a major portion of the slurry-phase hydrocracking effluents, all, a substantial portion, a significant portion or a major portion of the second ADU fraction, all, a substantial portion, a significant portion or a major portion of the first VDU fraction, and all or a portion of a fourth FCC fraction are processed in an inline hydrotreating zone for hydrodesulfurization and/or hydrodenitrogenation to produce a hydrotreated effluent. The hydrotreated effluent are fractionated into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons. All, a substantial portion, a significant portion or a major portion of the third cracked/hydrotreated fraction is processed in a fluidized catalytic cracking zone for catalytic cracking to produce FCC effluents and separating the FCC effluents into at least a light gas stream including hydrogen, C1 hydrocarbons and C2 hydrocarbons, a first FCC fraction comprising C3 hydrocarbons, a second FCC fraction comprising C4 hydrocarbons, a third FCC fraction comprising FCC naphtha, a fourth FCC fraction comprising light cycle oil, and a fifth FCC fraction comprising heavy cycle oil and/or FCC slurry oil. All, a substantial portion, a significant portion or a major portion of each of the first cracked/hydrotreated fraction, the second cracked/hydrotreated fraction, the first FCC fraction, the third FCC fraction, the first ADU fraction are processed in a petrochemicals production complex to produce light olefins and aromatic products. The first ADU fraction is optionally first subjected to a naphtha hydrotreating step before processing in the petrochemicals production complex are processed in a petrochemicals production complex to produce light olefins and aromatic products.

In some embodiments, a crude oil feedstream is subjected to solvent deasphalting to produce a deasphalted crude oil stream and asphalt. The deasphalted crude oil stream is separated by atmospheric distillation into at least a first ADU fraction comprising straight run naphtha, a second ADU fraction comprising middle distillates, and a third ADU fraction comprising atmospheric residue. All, a substantial portion, a significant portion or a major portion of the third ADU fraction is processed in a slurry-phase hydrocracking reaction zone to produce slurry-phase hydrocracking effluents. The processing in the slurry-phase hydrocracking reaction zone includes dispersing an effective amount of catalyst in the slurry-phase hydrocracking feed as a reactant-catalyst dispersion and passing an effective amount of a hydrogen-containing gas through the reactant-catalyst dispersion. Hydrocarbons in the slurry-phase hydrocracking feed are cracked into free-radical hydrocarbons of reduced size and the free-radical hydrocarbons are stabilized by hydrogen from the hydrogen-containing gas. At least a first stream of slurry-phase hydrocracking effluents is discharged including unreacted hydrogen and which is under hydrogen partial pressure, and discharging a second stream of unconverted bottoms. All, a substantial portion, a significant portion or a major portion of the slurry-phase hydrocracking effluents, all, a substantial portion, a significant portion or a major portion of the second ADU fraction and all or a portion of a fourth FCC fraction are processed in an inline hydrotreating zone for hydrodesulfurization and/or hydrodenitrogenation to produce a hydrotreated effluent. The hydrotreated effluent are fractionated into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons. All, a substantial portion, a significant portion or a major portion of the third cracked/hydrotreated fraction is processed in a fluidized catalytic cracking zone for catalytic cracking to produce FCC effluents and separating the FCC effluents into at least a light gas stream including hydrogen, C1 hydrocarbons and C2 hydrocarbons, a first FCC fraction comprising C3 hydrocarbons, a second FCC fraction comprising C4 hydrocarbons, a third FCC fraction comprising FCC naphtha, a fourth FCC fraction comprising light cycle oil, and a fifth FCC fraction comprising heavy cycle oil and/or FCC slurry oil. All, a substantial portion, a significant portion or a major portion of each of the first cracked/hydrotreated fraction, the second cracked/hydrotreated fraction, the first FCC fraction, the third FCC fraction, the first ADU fraction are processed in a petrochemicals production complex to produce light olefins and aromatic products. The first ADU fraction is optionally first subjected to a naphtha hydrotreating step before processing in the petrochemicals production complex are processed in a petrochemicals production complex to produce light olefins and aromatic products.

In some embodiments, a slurry-phase hydrocracking feed comprising residue stream and/or a deasphalted residue stream is processed in a slurry-phase hydrocracking reaction zone to produce slurry-phase hydrocracking effluents. The processing in the slurry-phase hydrocracking reaction zone includes dispersing an effective amount of catalyst in the slurry-phase hydrocracking feed as a reactant-catalyst dispersion and passing an effective amount of a hydrogen-containing gas through the reactant-catalyst dispersion. Hydrocarbons in the slurry-phase hydrocracking feed are cracked into free-radical hydrocarbons of reduced size and the free-radical hydrocarbons are stabilized by hydrogen from the hydrogen-containing gas. At least a first stream of slurry-phase hydrocracking effluents is discharged including unreacted hydrogen and which is under hydrogen partial pressure, and discharging a second stream of unconverted bottoms. All, a substantial portion, a significant portion or a major portion of the slurry-phase hydrocracking effluents are processed in an inline hydrotreating zone for hydrodesulfurization and/or hydrodenitrogenation to produce a hydrotreated effluent. The hydrotreated effluent are fractionated into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons. All, a substantial portion, a significant portion or a major portion of the third cracked/hydrotreated fraction is processed in a fluidized catalytic cracking zone for catalytic cracking to produce FCC effluents and separating the FCC effluents into at least a light gas stream including hydrogen, C1 hydrocarbons and C2 hydrocarbons, a first FCC fraction comprising C3 hydrocarbons, a second FCC fraction comprising C4 hydrocarbons, a third FCC fraction comprising FCC naphtha, a fourth FCC fraction comprising light cycle oil, and a fifth FCC fraction comprising heavy cycle oil and/or FCC slurry oil. All, a substantial portion, a significant portion or a major portion of the fourth FCC fraction is passed to the inline hydrotreating zone. All, a substantial portion, a significant portion or a major portion of each of the first cracked/hydrotreated fraction, the second cracked/hydrotreated fraction, the first FCC fraction and the third FCC fraction are processed in a petrochemicals production complex to produce light olefins and aromatic products.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1 is a simplified schematic diagram a process and system for petrochemical production integrating slurry hydrocracking and in-line hydrotreating;

FIG. 2 is a simplified schematic diagram a process and system for petrochemical production integrating slurry hydrocracking and in-line hydrotreating;

FIG. 3 is a simplified schematic diagram a process and system for petrochemical production integrating slurry hydrocracking and in-line hydrotreating;

FIG. 4 is a simplified schematic diagram a process and system for petrochemical production integrating slurry hydrocracking and in-line hydrotreating;

FIG. 5 is a simplified schematic diagram a process and system for petrochemical production integrating slurry hydrocracking and in-line hydrotreating;

FIG. 6 is a simplified schematic diagram a process and system for petrochemical production integrating slurry hydrocracking and in-line hydrotreating;

FIG. 7 is a simplified schematic diagram of a petrochemical production complex;

FIG. 8A is a simplified schematic diagram of a downflow FCC reactor; and

FIG. 8B is a simplified schematic diagram of a riser FCC reactor.

### DETAILED DESCRIPTION OF CERTAIN EMBODIMENTS OF THE DISCLOSURE

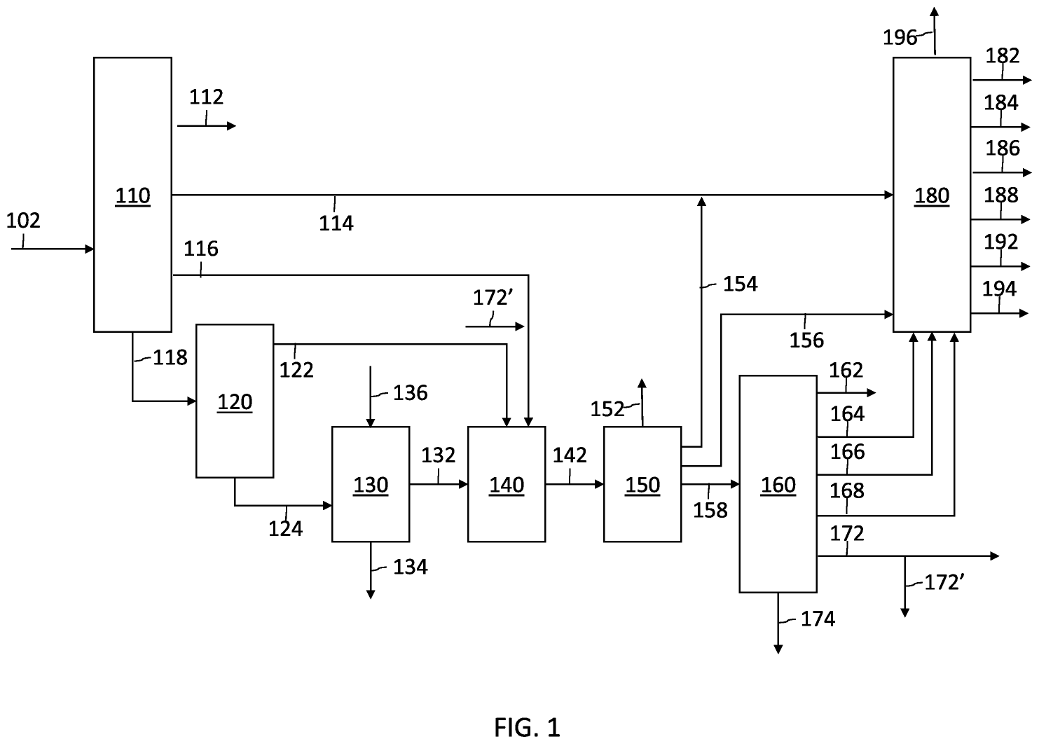

FIG. 1 schematically depicts an embodiment of a process and system for petrochemical production integrating slurry hydrocracking and in-line hydrotreating for petrochemical production including ethylene, propylene and other valuable petrochemical products. The system generally includes an atmospheric distillation zone 110, a vacuum distillation zone 120, a slurry-phase hydrocracking zone 130, an inline hydrotreating zone 140, a fractionation zone 150, a fluidized catalytic cracking zone 160 and a petrochemicals production complex 180.

A feed 102 is separated in the atmospheric distillation zone 110 into fractions including at least a first ADU fraction comprising straight run naphtha 114, a second ADU fraction comprising middle distillates 116, and a third ADU fraction comprising atmospheric residue 118. In some embodiments the feed 102 is crude oil. In some embodiments, LPG, or light ends, 112 is also separated in the ADU. The third ADU fraction comprising atmospheric residue 118 can be separated in a vacuum distillation unit (VDU) 120 into at least a first VDU fraction comprising vacuum gas oil 122, and a second VDU fraction comprising vacuum residue 124.

All, a substantial portion, a significant portion or a major portion of the second VDU fraction comprising vacuum residue 124 is routed to a slurry-phase hydrocracking reaction zone 130 to produce slurry-phase hydrocracking effluents. In some embodiments, the slurry-phase hydrocracking reaction zone 130 operates by dispersing an effective amount of catalyst in the slurry-phase hydrocracking feed, which is the second VDU fraction comprising vacuum residue 124 in FIG. 1, as a reactant-catalyst dispersion. An effective amount of a hydrogen-containing gas 136 is passed through the reactant-catalyst dispersion, wherein hydrocarbons in the slurry-phase hydrocracking feed are cracked into free-radical hydrocarbons of reduced size and wherein the free-radical hydrocarbons are stabilized by hydrogen from the hydrogen-containing gas. A first stream of slurry-phase hydrocracking effluents 132 is discharged. The first stream of slurry-phase hydrocracking effluents 132 includes unreacted hydrogen and which is under hydrogen partial pressure. A second stream of unconverted bottoms 134 is also discharged from the slurry-phase hydrocracking reaction zone 130.

All, a substantial portion, a significant portion or a major portion of the second ADU fraction 116, all, a substantial portion, a significant portion or a major portion of the first VDU fraction 122, all, a substantial portion, a significant portion or a major portion of the slurry-phase hydrocracking effluents 132, and all or a portion of a fourth FCC fraction 172′ is passed to in-line hydrotreating zone 140 for processing via hydrodesulfurization and/or hydrodenitrogenation to produce a hydrotreated effluent 142. The hydrotreated effluent 142 is routed to fractionation zone 150 for separation into a gas fraction 152, a first cracked/hydrotreated fraction 154 comprising naphtha-range hydrocarbons, a second cracked/hydrotreated fraction 156 comprising middle distillate-range hydrocarbons and a third cracked/hydrotreated fraction 158 comprising vacuum gas oil-range hydrocarbons. In some embodiments (not shown) the a first cracked/hydrotreated fraction 154 comprising naphtha-range hydrocarbons, a second cracked/hydrotreated fraction 156 comprising middle distillate-range hydrocarbons are part of a same stream comprising both cracked/hydrotreated naphtha- and middle distillate-range hydrocarbons. The third cracked/hydrotreated fraction 158 comprising vacuum gas oil-range hydrocarbons. The cut point of the third cracked/hydrotreated fraction 158 is in the range corresponding to VGO, i.e., 370-525° C. In some embodiments, the separation in fractionation zone 150 is under atmospheric conditions.

All, a substantial portion, a significant portion or a major portion of the third cracked/hydrotreated fraction 158 is routed to the fluidized catalytic cracking zone 160 to produce FCC effluents, which are separated into at least a light gas stream 162 including hydrogen, C1 hydrocarbons and C2 hydrocarbons, a first FCC fraction 164 comprising C3 hydrocarbons, a second FCC fraction 166 comprising C4 hydrocarbons, a third FCC fraction 168 comprising FCC naphtha, a fourth FCC fraction 172 comprising light cycle oil, and a fifth FCC fraction 174 comprising heavy cycle oil and/or FCC slurry oil. In some embodiments, the third FCC fraction 168 corresponds to multiple streams, such as a light naphtha stream and a heavy naphtha stream. All, a substantial portion, a significant portion or a major portion of the fourth FCC fraction is passed to the inline hydrotreating zone 140. In some embodiments, all or a portion 172′ of the fourth FCC fraction is passed to in-line hydrotreating zone 140 for processing. Any remaining portion can be sent to a fuel pool. In some embodiments, the fifth FCC fraction 174 corresponds to multiple stream, such as heavy cycle oil and FCC slurry oil. In some embodiments, the fifth FCC fraction 174 comprises heavy cycle oil that is passed to a fuel oil pool. In some embodiments, the fifth FCC fraction 174 comprises FCC slurry oil which is passed to the inline hydrotreating zone 140. In such embodiments, any solid FCC catalyst remining in the fifth FCC fraction 174 can be removed according to known methods in the art. In some embodiments, coke on the catalyst is also represented by stream 174, and a skilled artisan would appreciate that this is combusted in the catalyst regeneration step.

All, a substantial portion, a significant portion or a major portion of each of the first cracked/hydrotreated fraction 154, the second cracked/hydrotreated fraction 156, the first FCC fraction 164, the third FCC fraction 168, and optionally the first ADU fraction 114 are processed in the petrochemical production complex 180 to produce light olefins and aromatic products. In some embodiments, the products from the petrochemical production complex 180 include a gas fraction 182, an ethylene fraction 184, a propylene fraction 186, a butadiene's fraction 188, a benzene and paraxylene fraction 192, a tar fraction 194, and a hydrogen fraction 196.

In some embodiments, one or more of the first cracked/hydrotreated fraction 154, the second cracked/hydrotreated fraction 156, the first FCC fraction 164, the third FCC fraction 168, and optionally the first ADU fraction 114 are subjected to a naphtha hydrotreating step (not shown).

In some embodiments (not shown), if the third FCC fraction 168 comprising FCC naphtha does not contain C7-C9 aromatics, it can optionally be passed to steam cracking unit 210.

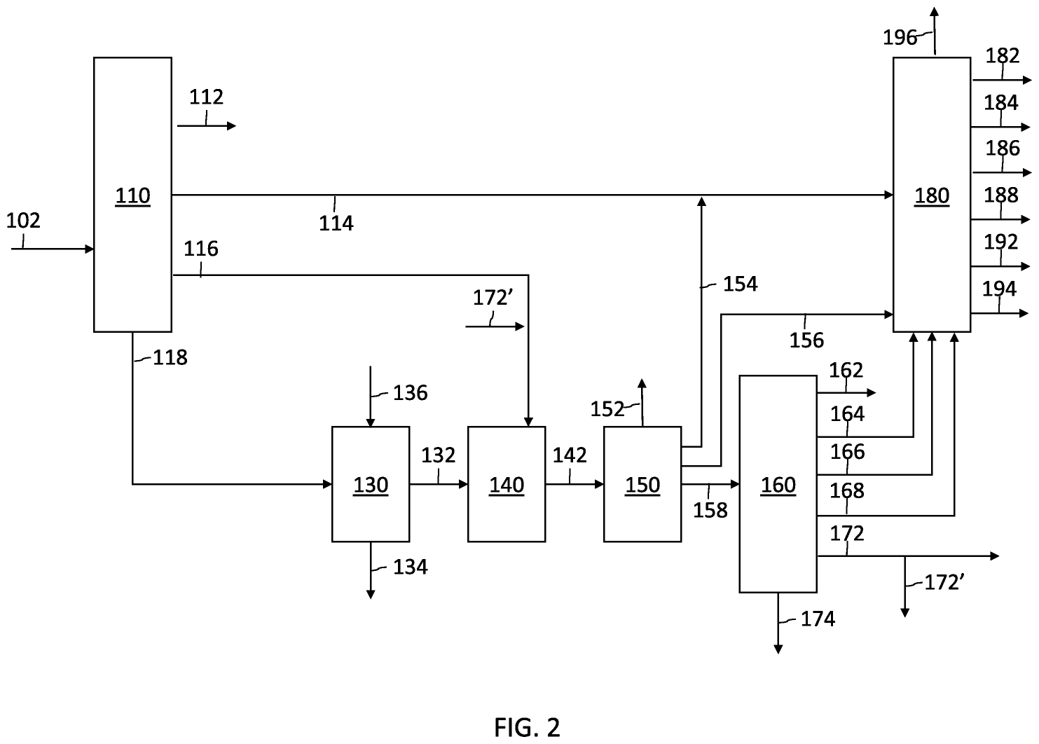

FIG. 2 schematically depicts an embodiment of a process and system for petrochemical production integrating slurry hydrocracking and in-line hydrotreating for petrochemical production including ethylene, propylene and other valuable petrochemical products. The system generally includes an atmospheric distillation zone 110, a slurry-phase hydrocracking zone 130, an inline hydrotreating zone 140, a fractionation zone 150, a fluidized catalytic cracking zone 160 and a petrochemicals production complex 180.

In this embodiment, the third ADU fraction comprising atmospheric residue 118 is routed to the slurry-phase hydrocracking reaction zone 130 to produce slurry-phase hydrocracking effluents. All, a substantial portion, a significant portion or a major portion of the second ADU fraction 116, all, a substantial portion, a significant portion or a major portion of the slurry-phase hydrocracking effluents 132, and all or a portion of a fourth FCC fraction 172′ is passed to in-line hydrotreating zone 140 for processing via hydrodesulfurization and/or hydrodenitrogenation to produce a hydrotreated effluent 142.

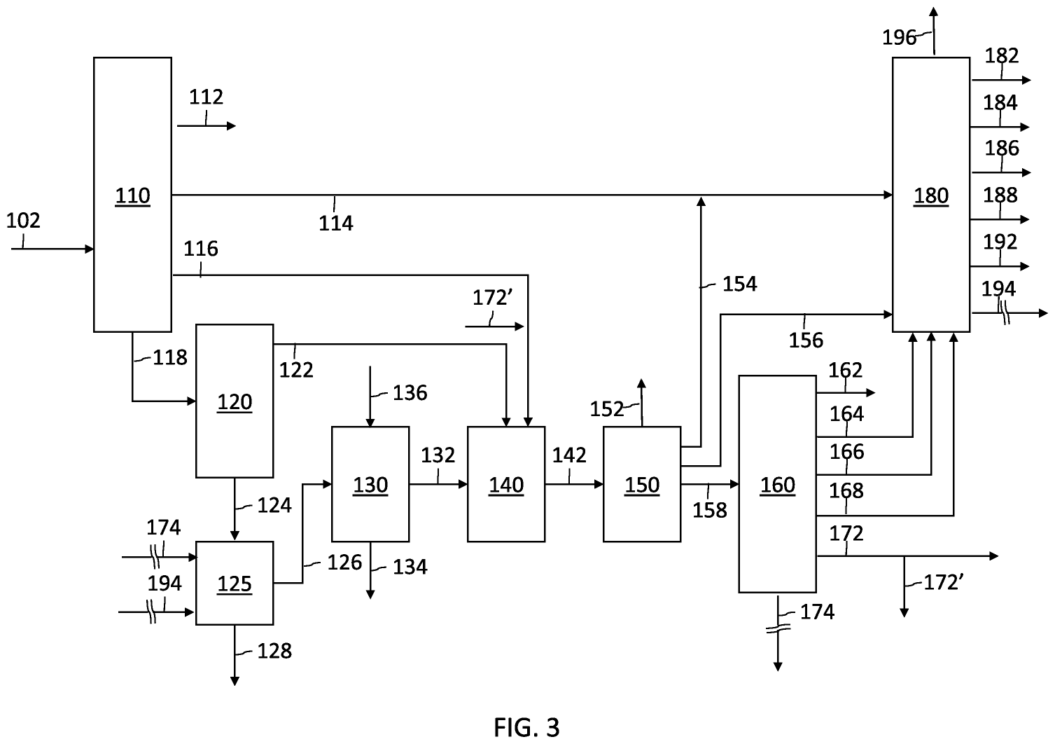

FIG. 3 schematically depicts an embodiment of a process and system for petrochemical production integrating slurry hydrocracking and in-line hydrotreating for petrochemical production including ethylene, propylene and other valuable petrochemical products. The system generally includes an atmospheric distillation zone 110, a vacuum distillation zone 120, a solvent deasphalting zone 125, a slurry-phase hydrocracking zone 130, an inline hydrotreating zone 140, a fractionation zone 150, a fluidized catalytic cracking zone 160 and a petrochemicals production complex 180.

In this embodiment, the second VDU fraction comprising vacuum residue 124, the fifth FCC fraction 174, and tar 194 are routed to solvent deasphalting zone 125 to produce a solvent deasphalted vacuum residue 126 and asphalt 128. The solvent deasphalted vacuum residue 126 is routed to the slurry-phase hydrocracking reaction zone 130 to produce slurry-phase hydrocracking effluents.

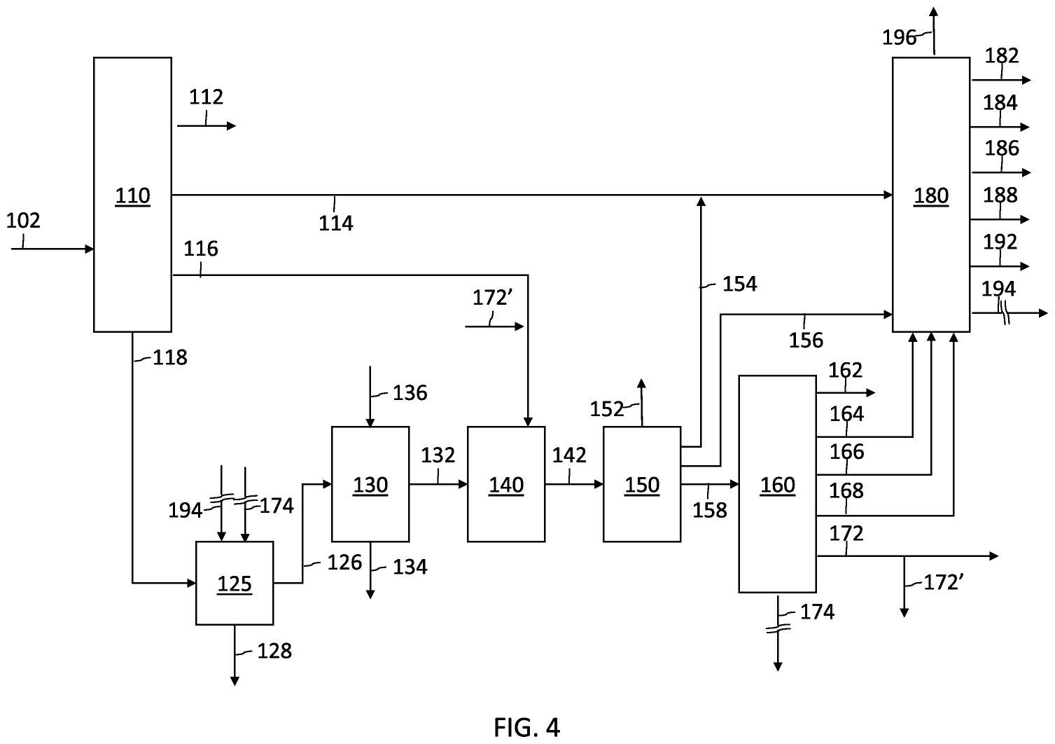

FIG. 4 schematically depicts an embodiment of a process and system for petrochemical production integrating slurry hydrocracking and in-line hydrotreating for petrochemical production including ethylene, propylene and other valuable petrochemical products. The system generally includes an atmospheric distillation zone 110, a solvent deasphalting zone 125, a slurry-phase hydrocracking zone 130, an inline hydrotreating zone 140, a fractionation zone 150, a fluidized catalytic cracking zone 160 and a petrochemicals production complex 180.

In this embodiment, the third ADU fraction comprising atmospheric residue 118, the fifth FCC fraction 174, and tar 194 are routed to solvent deasphalting zone 125 to produce a solvent deasphalted atmospheric residue 126 and asphalt 128. The solvent deasphalted atmospheric residue 126 is routed to the slurry-phase hydrocracking reaction zone 130 to produce slurry-phase hydrocracking effluents. All, a substantial portion, a significant portion or a major portion of the second ADU fraction 116, all, a substantial portion, a significant portion or a major portion of the slurry-phase hydrocracking effluents 132, and all or a portion of a fourth FCC fraction 172′ is passed to in-line hydrotreating zone 140 for processing via hydrodesulfurization and/or hydrodenitrogenation to produce a hydrotreated effluent 142.

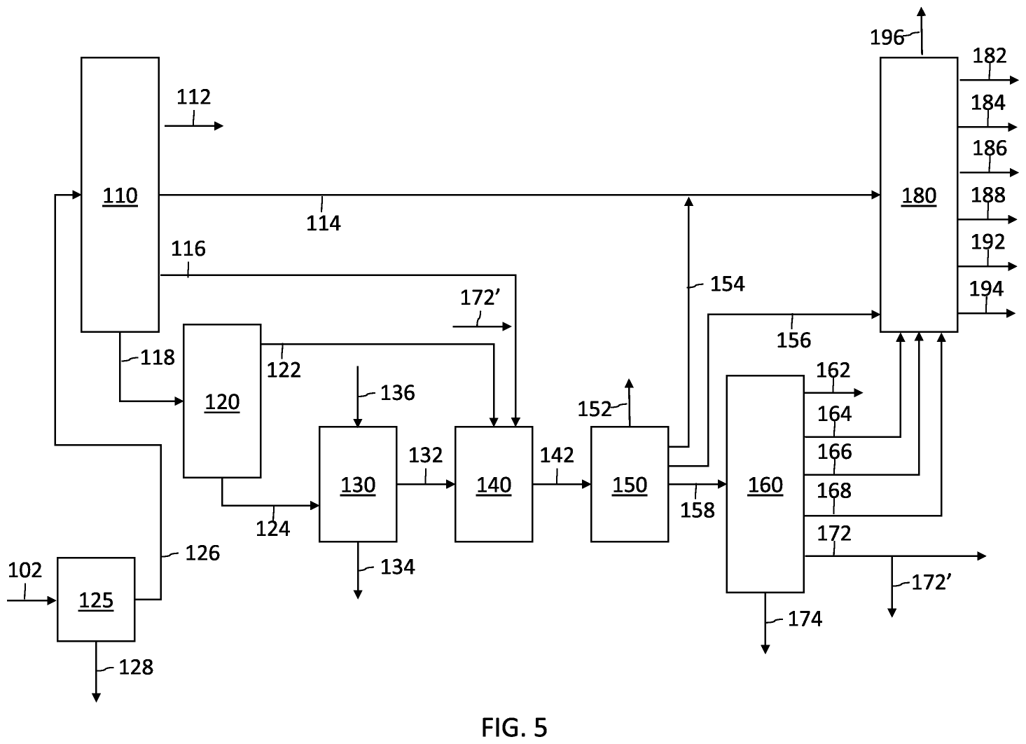

FIG. 5 schematically depicts an embodiment of a process and system for petrochemical production integrating slurry hydrocracking and in-line hydrotreating for petrochemical production including ethylene, propylene and other valuable petrochemical products. The system generally includes an atmospheric distillation zone 110, a vacuum distillation zone 120, a solvent deasphalting zone 125, a slurry-phase hydrocracking zone 130, an inline hydrotreating zone 140, a fractionation zone 150, a fluidized catalytic cracking zone 160 and a petrochemicals production complex 180.

In this embodiment, the feed 102 is routed to a solvent deasphalting zone 125 to produce a solvent deasphalted crude oil 126 and asphalt 128. The solvent deasphalted crude oil 126 is separated in the atmospheric distillation zone 110 into fractions including at least a first ADU fraction comprising straight run naphtha 114, a second ADU fraction comprising middle distillates 116, and a third ADU fraction comprising atmospheric residue 118. In some embodiments, LPG, or light ends, 112 is also separated in the ADU.

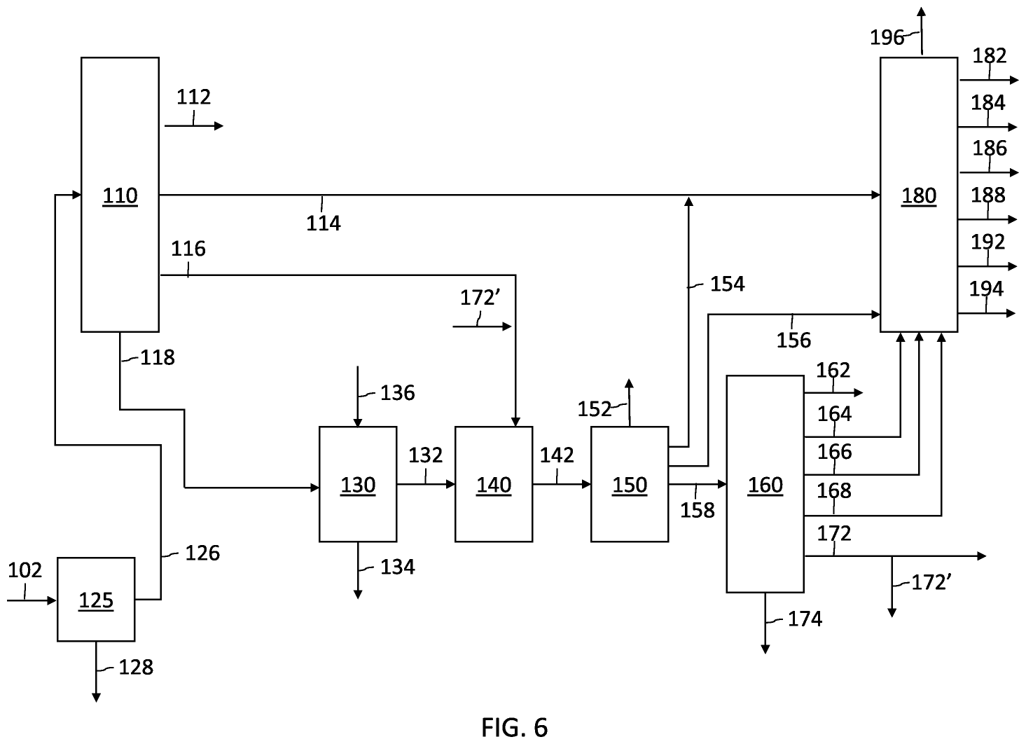

FIG. 6 schematically depicts an embodiment of a process and system for petrochemical production integrating slurry hydrocracking and in-line hydrotreating for petrochemical production including ethylene, propylene and other valuable petrochemical products. The system generally includes an atmospheric distillation zone 110, a solvent deasphalting zone 125, a slurry-phase hydrocracking zone 130, an inline hydrotreating zone 140, a fractionation zone 150, a fluidized catalytic cracking zone 160 and a petrochemicals production complex 180.

In this embodiment, the feed 102 is routed to a solvent deasphalting zone 125 to produce a solvent deasphalted crude oil 126 and asphalt 128. The solvent deasphalted crude oil 126 is separated in the atmospheric distillation zone 110 into fractions including at least a first ADU fraction comprising straight run naphtha 114, a second ADU fraction comprising middle distillates 116, and a third ADU fraction comprising atmospheric residue 118. In some embodiments, LPG, or light ends, 112 is also separated in the ADU. In this embodiment, the third ADU fraction comprising atmospheric residue 118 is routed to the slurry-phase hydrocracking reaction zone 130 to produce slurry-phase hydrocracking effluents. All, a substantial portion, a significant portion or a major portion of the second ADU fraction 116, all, a substantial portion, a significant portion or a major portion of the slurry-phase hydrocracking effluents 132, and all or a portion of a fourth FCC fraction 172′ is passed to in-line hydrotreating zone 140 for processing via hydrodesulfurization and/or hydrodenitrogenation to produce a hydrotreated effluent 142.

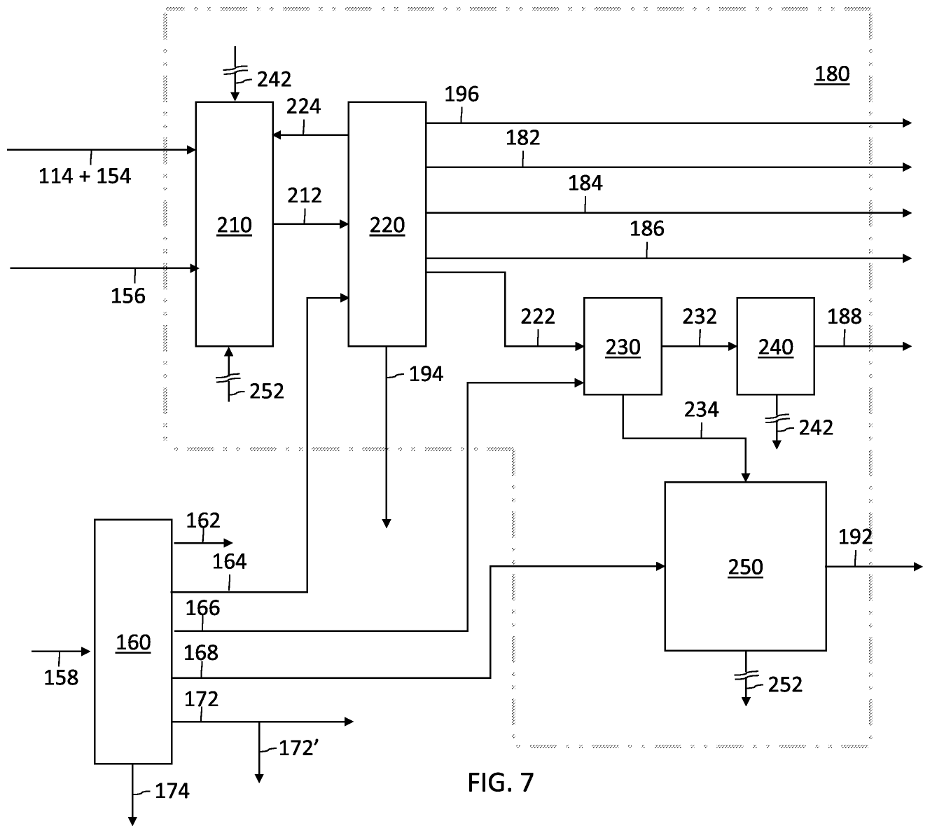

FIG. 7 schematically depicts the petrochemicals production complex 180 used in certain embodiments. In some embodiments, the first cracked/hydrotreated fraction 154 and the second cracked/hydrotreated fraction 156 are routed to stream cracking zone 210 for steam cracking to produce at least steam cracking gas effluents 212 and recovery of light olefins and aromatic products from the steam cracking gas effluents. In some embodiments the first cracked/hydrotreated fraction 154, the second cracked/hydrotreated fraction 156, and all or a portion of the first ADU fraction 114 are routed to stream cracking zone 210 for steam cracking to produce at least steam cracking gas effluents 212 and recovery of light olefins and aromatic products from the steam cracking gas effluents. The steam cracking gas effluents 212 and the first FCC fraction 164 are routed to compression zone 220 to separate at least hydrogen 196, methane 182, ethylene 184, propylene 186, tar 194 and mixed C4+ hydrocarbons 222. In some embodiments, tar 194 and includes pyrolysis oil. Compression zone 220 also produces an internal recycle stream 224 that can be routed back to the stream cracking zone 210. In some embodiment, internal recycle stream 224 includes ethane and propane

The mixed C4+ hydrocarbons 222 and the second FCC fraction 166 are routed to debutanizer zone 230 to separate mixed C4 hydrocarbons 232 and mixed C5+ hydrocarbons 234. In some embodiments, mixed C5+ hydrocarbons 234 includes pyrolysis gasoline. In some embodiments, the mixed C4 hydrocarbons 232 is optionally hydrogenated (not shown) to produce hydrogenated mixed C4 hydrocarbons. The mixed C4 hydrocarbons and/or optional hydrogenated mixed C4 hydrocarbons 232 is sent to extractor 240 to produce butadiene and an internal non-aromatic C4 raffinate stream 242. The mixed C5+ hydrocarbons 234 and the third FCC fraction 168 are routed to aromatic complex 250 for separation into a benzene and paraxylene stream 192 and a raffinate stream 252. In some embodiments, raffinate stream 252 and internal non-aromatic C4 raffinate stream 242 are recycled internally to stream cracking zone 210. In some embodiments, if the third FCC fraction 168 includes all, a substantial portion, a significant portion or a major portion of diolefins and/or monoolefins, then the third FCC fraction 168 can be optionally hydrotreated (not shown) before being routed to the aromatic complex 250.

In some embodiments, not shown, aromatic complex 250 also includes a transalkylation unit and produces a C11+ aromatic bottoms stream. In some embodiments, not shown, aromatic complex 250 produces a C9+ aromatic bottoms stream and does not include a transalkylation unit.

In some embodiments, the C11+ aromatic bottoms stream can be hydrodearylated in a separate unit, processed in other units such as those in the inline hydrotreating zone or slurry phase hydrocracking zone, or sent to a fuel oil pool.

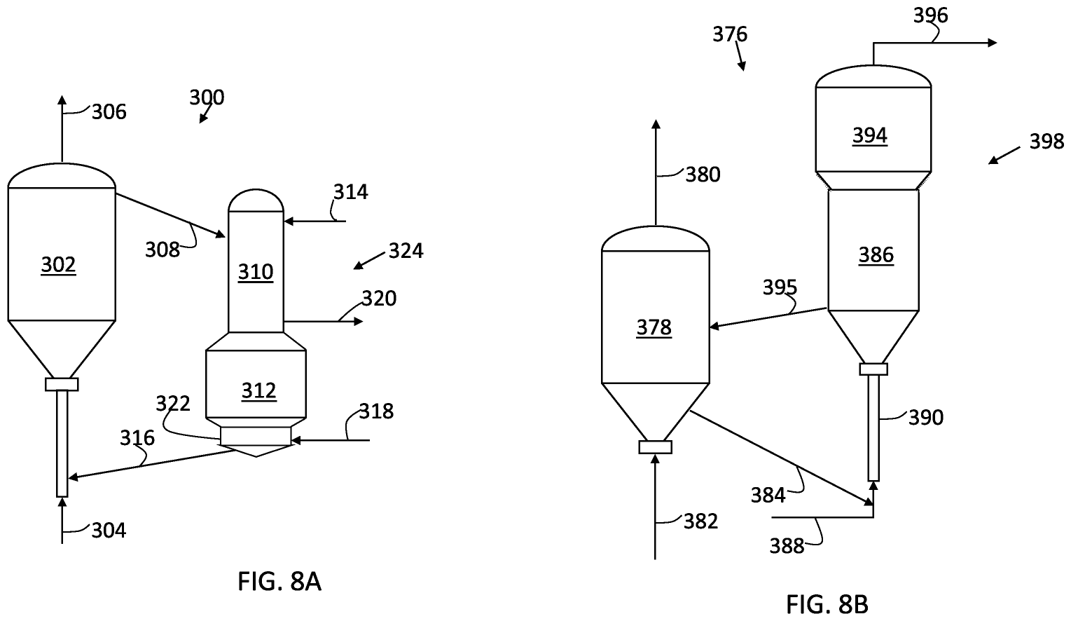

FIG. 8A and FIG. 8B are schematic diagrams of examples of FCC reactors that can serve as fluidized catalytic cracking zone 160 herein. In certain embodiments plural reactors can be implemented to maximize propylene yield and selectivity.

In certain embodiments, an FCC unit configured with a downflow reactor is provided that operates under conditions that promote formation of light olefins, particularly propylene, and that minimize light olefin-consuming reactions including hydrogen-transfer reactions. A downflow reactor is schematically depicted in FIG. 8A, which can represent the fluidized catalytic cracking zone 160 of FIGS. 1-6.

A downflow FCC unit 300 includes a reactor/separator 324 having a reaction zone 310 and a separation zone 312; and a regeneration zone 302 for regenerating spent catalyst. In particular, a charge 314, which can be the third cracked/hydrotreated fraction 158 comprising vacuum gas oil-range hydrocarbons, is introduced to the reaction zone, in certain embodiments accompanied by steam or other suitable gas for atomization of the feed (not shown). An effective quantity of heated fresh or hot regenerated solid cracking catalyst particles from the regeneration zone 302 are conveyed to the top of the reaction zone 310 also transferred, for instance, through a downwardly directed conduit or pipe 308, commonly referred to as a transfer line or standpipe, to a withdrawal well or hopper (not shown) at the top of reaction zone 310. Hot catalyst flow is typically allowed to stabilize in order to be uniformly directed into the mix zone or the feed injection portion of the reaction zone 310. The charge 314 is injected into a mixing zone through feed injection nozzles typically situated proximate to the point of introduction of the regenerated catalyst into reaction zone 310. These multiple injection nozzles result in the thorough and uniform mixing of the hot catalyst and the charge 314, in the integrated process herein hydrotreated gas oil. Once the charge contacts the hot catalyst, cracking reactions occur.

The reaction vapor of hydrocarbon cracked products, unreacted feed and catalyst mixture quickly flows through the remainder of the reaction zone 310 and into the rapid separation zone 312 at the bottom portion of the reactor/separator 324. Cracked and uncracked hydrocarbons are directed through a conduit or pipe 320 to a conventional product recovery section known in the art to yield fluid catalytic cracking products. If necessary, for temperature control, a quench injection can be provided near the bottom of the reaction zone 310 immediately before the separation zone 312. This quench injection quickly reduces or stops the cracking reactions and can be utilized for controlling cracking severity to achieve the product slate.

The reaction temperature, for instance, the outlet temperature of the downflow reactor, can be controlled by opening and closing a catalyst slide valve (not shown) that controls the flow of hot regenerated catalyst from the regeneration zone 302 into the top of the reaction zone 310. The heat required for the endothermic cracking reaction is supplied by the regenerated catalyst. By changing the flow rate of the hot regenerated catalyst, the operating severity or cracking conditions can be controlled to produce the desired product slate. A stripper 322 is also provided for separating oil from the catalyst, which is transferred to the regeneration zone 302. The catalyst from the separation zone 312 flows to the lower section of the stripper 322 that includes a catalyst stripping section into which a suitable stripping gas, such as steam, is introduced through streamline 318. The stripping section is typically provided with several baffles or structured packing (not shown) over which the downwardly flowing catalyst 316 passes counter-currently to the flowing stripping gas. The upwardly flowing stripping gas, which is typically steam, is used to “strip” or remove any additional hydrocarbons that remain in the catalyst pores or between catalyst particles. The stripped and spent catalyst is transported by lift forces from the combustion air stream 304 through a lift riser of the regeneration zone 312. This spent catalyst, which can also be contacted with additional combustion air, undergoes controlled combustion of any accumulated coke. Flue gases are removed from the regenerator via conduit 306. In the regenerator, the heat produced from the combustion of the by-product coke is transferred to the catalyst raising the temperature required to provide heat for the endothermic cracking reaction in the reaction zone 310.

In certain embodiments, an FCC unit configured with a riser reactor is provided that operates under conditions that promote formation of light olefins, particularly propylene, and that minimize light olefin-consuming reactions including hydrogen-transfer reactions. A riser reactor is schematically depicted in FIG. 8B, which can represent the fluidized catalytic cracking zone 160 of FIGS. 1-6.

The riser FCC unit 376 includes a reactor/separator 398 having a riser portion 390, a reaction zone 386 and a separation zone 394; and a regeneration vessel 378 for regenerating spent catalyst. A charge 388 is introduced to the reaction zone, in certain embodiments accompanied by steam or other suitable gas for atomization of the feed (not shown). The charge 388, which can be the third cracked/hydrotreated fraction 158 comprising vacuum gas oil-range hydrocarbons, is admixed and intimately contacted with an effective quantity of heated fresh or regenerated solid cracking catalyst particles which are conveyed via a conduit 384 from the regeneration vessel 378. The feed mixture and the cracking catalyst are contacted under conditions to form a suspension that is introduced into the riser 390. In a continuous process, the mixture of cracking catalyst and hydrocarbon feedstock proceed upward through the riser 390 into the reaction zone 386. In the riser 390 and reaction zone 386, the hot cracking catalyst particles catalytically crack relatively large hydrocarbon molecules by carbon-carbon bond cleavage.

During the reaction, as is typical in FCC operations, the cracking catalysts become coked and hence access to the active catalytic sites is limited or nonexistent. Reaction products are separated from the coked catalyst using any suitable configuration known in FCC units, generally referred to as the separation zone 394 in an FCC unit 376, for instance, located at the top of the reactor 398 above the reaction zone 386. The separation zone can include any suitable apparatus known to those of ordinary skill in the art such as, for example, cyclones. The reaction product is withdrawn through conduit 396. Catalyst particles containing coke deposits from fluid cracking of the hydrocarbon feedstock pass through a conduit 395 to the regeneration zone 378.

In the regeneration zone 378, the coked catalyst comes into contact with a stream of oxygen-containing gas, such as pure oxygen or air, which enters the regeneration zone 378 via a conduit 382. The regeneration zone 378 is operated in a configuration and under conditions that are known in typical FCC operations. For instance, the regeneration zone 378 can operate as a fluidized bed to produce regeneration off-gas comprising combustion products which is discharged through a conduit 380. The hot regenerated catalyst is transferred from the regeneration zone 378 through the conduit 384 to the bottom portion of the riser 390 for admixture with the hydrocarbon feedstock and noted above.

In some embodiments, all or a portion of the second stream of unconverted bottoms 134 is routed to solvent deasphalting zone 125 (not shown).

Slurry-phase hydrocracking zone 130 uses catalyst particles having a very small average dimension that can be uniformly dispersed and maintained in the medium in order for efficient and immediate hydrogenation processes throughout the volume of the reactor. Slurry phase hydroprocessing operates at relatively high temperatures and high pressures. Because of the high severity of the process, a relatively higher conversion rate can be achieved. In general, in a slurry bed reactor, the catalyst is suspended in a liquid through which a gas is bubbled. The mechanism in a slurry bed reactor is a thermal cracking process and is based on free radical formation. The free radicals formed are stabilized with hydrogen in the presence of catalysts, thereby preventing the coke formation.

In some embodiments, a slurry bed reactor can be a two-or-three phase reactor, depending on the type of catalysts utilized. A two-phase system includes gas and liquid when homogeneous catalysts are employed, and a three-phase system includes gas, liquid and solid when small particle size heterogeneous catalysts are employed. The soluble liquid precursor or small particle size catalysts permit high dispersion of catalysts in the liquid resulting in intimate contact between catalyst and feedstock, thus maximizing the conversion rate.

In certain embodiments, slurry-phase hydrocracking zone 130 includes a hydrocracking slurry bed reactor operating under the following conditions:

a temperature in the range of from 380-600, 380-550, 380-500, 400-600, 400-550, 400-500, 420-600, 420-550, or 420-500° C.,

a pressure in the range of from 100-250, 100-220, 100-200, 120-250, 120-220, 120-200, 130-250, 130-220, or 130-200 bars,

a LHSV in the range of from 0.1-4.0, 0.1-1.0, 0.1-0.5, 0.2-4.0, 0.2-1.0, 0.2-0.5, 0.3-4.0, 0.3-1.0, or 0.3-0.5 h-1, and

a hydrogen gas feed rate (standard liters per liter of hydrocarbon feed, SLt/Lt) in the range of from 500-2500, 500-2000, 500-1800, 800-2500, 800-2000, 800-1800, 1000-2500, 1000-2000, or 1000-1800 L/L.

In some embodiments, effective hydrocracking catalyst for slurry-phase hydrocracking zone 130 include soluble organic precursors or heterogeneous particles. The soluble organic precursor can include one or more transition metal complexes, precursors, or ligands including one or more of Mo, W, Ni, Co, Fe, Ru or Cu. In some embodiments, the catalyst contains one or more of Mo, W, Ni, Co, or Fe. In the case of heterogeneous catalysts, the support materials can be oxides of iron, coal, activated carbon, alumina, silica-alumina, and other known materials. The support material can be nano-sized particles (i.e., from 1 to 5000 nanometers) or particles with a size less than or equal to 3 mm.

In some embodiments, effective hydrocracking catalyst for slurry-phase hydrocracking zone 130 comprises a transition metal complex and an aromatic bottoms comprising C9 aromatics, C10 aromatics, C11 aromatics, C11+ aromatics, or a combination thereof, wherein the transition metal complex is dissolved or dispersed in the aromatic bottoms, wherein the transition metal complex comprises ligands, organometallics, salts, oxides, sulfides, or a combination thereof. In some embodiments, the ligands comprise oxygen groups, and the oxygen groups are bonded to a metal. In some embodiments, the transition metal complex comprises bis(acetylacetonato)dioxomolybdenum (VI), molybdenum trioxide, molybdenum hexacarbonyl, or a combination thereof. In some embodiments, the transition metal complex comprises bis(acetylacetonato)dioxomolybdenum (VI) and the aromatic bottoms comprises at least 60 weight percent of monoaromatic hydrocarbons.

In some embodiments, effective hydrocracking catalyst for slurry-phase hydrocracking zone 130 comprises a transition metal complex, and a disulfide oil, wherein the disulfide oil is a reaction product of a mercaptan oxidation reaction, the metal complex is dissolved in the disulfide oil to form a mixed catalyst composition, and at least a portion of the mixed catalyst composition is transferred to a slurry-phase hydrocracking unit to form the catalyst for processing in the slurry-phase hydrocracking reaction zone. In some embodiments, the metal complex comprises ligands including oxygen groups, and wherein the oxygen groups are bonded to a metal. In some embodiments, the metal complex comprises bis(acetylacetonato)dioxomolybdenum (VI), molybdenum trioxide, molybdenum hexacarbonyl, or a combination thereof. In some embodiments, the disulfide oil comprises dimethyldisulfude, diethyldisulfide, methylethyldisulfide, or a combination thereof. In some embodiments, the concentration of the metal complex is greater than a solubility limit of the metal complex, or from 100 ppmw to 10,000 ppmw.

In some embodiments, effective hydrocracking catalyst for slurry-phase hydrocracking zone 130 comprises a disulfide oil and a first metal complex comprising at least one transition metal selected from the group consisting of molybdenum, cobalt, nickel, tungsten, iron, and combinations of these; and a plurality of ligands bonded to the at least one transition metal, wherein the plurality of ligands comprises at least one first ligand selected from the group consisting of dimethylsulfide, dimethyldisulfide, diethylsulfide, diethyldisulfide, methylethylsulfide, and methylethyldisulfide; the transition metal is bonded to a sulfur atom of the at least one first ligand, and the disulfide oil is a reaction product of a mercaptan oxidation reaction. In some embodiments, the disulfide oil comprises greater than or equal to 90 wt % of dimethyldisulfide, diethyldisulfide, methylethyldisulfide, or combinations thereof. In some embodiments, the plurality of ligands comprises at least one second ligand that is different from the at least one first ligand and wherein the at least one second ligand comprises one or more of oxo, acetylacetonate, iodide, bromide, sulfide, thiocyanate, chloride, nitrate, azide, fluoride, hydroxide, oxalate, water, nitrite, isothiocyanate, acetonitrile, pyridine, ammonia, ethylenediamine, 2,2′-bipyridine, 1,10-phenanthroline, nitrile, triphenylphosphine, cyanide, carbon monoxide, or an organometallic ligand. In some embodiments, the first metal complex comprises molybdenum (VI) dioxo acetylacetonate dimethylsulfide, molybdenum (VI) dioxo acetylacetonate di-dimethylsulfide, molybdenum (VI) dioxo dimethylsulfide methylethyldisulfide, or molybdenum sodium dioxo di-dimethylsulfide methylethyldisulfide and a concentration of the first metal complex is in the range of from 100 ppmw to 10,000 ppmw. In some embodiments, the concentration of the first metal complex is greater than a solubility limit of the metal complex. In some embodiments, the catalyst for processing in the slurry-phase hydrocracking reaction zone further comprises a second metal complex comprising at least one transition metal selected from the group consisting of molybdenum, cobalt, nickel, tungsten, iron, or combinations thereof; and at least one ligand, wherein the at least one ligand comprises one or more of oxo, acetylacetonate, iodide, bromide, sulfide, thiocyanate, chloride, nitrate, azide, fluoride, hydroxide, oxalate, water, nitrite, isothiocyanate, acetonitrile, pyridine, ammonia, ethylenediamine, 2,2′-bipyridine, 1,10-phenanthroline, nitrile, triphenylphosphine, cyanide, carbon monoxide, or an organometallic ligand. In some embodiments, the transition metal of the first metal complex is the same as the transition metal of the second metal complex. In some embodiments, the second metal complex comprises one or more of bis(acetylacetonato)dioxomolybdenum (VI), cobalt (III) acetylacetonate, acetylacetonato nickel, ferric tris(acetylacetonate), or sodium bis(acetylacetonato)dioxomolybdenum.

In certain embodiments, inline hydrotreating zone 140 includes a reactor operating under the following conditions:

a temperature in the range of from 350-450, 350-440, 350-430, 360-450, 360-440, 360-430, 370-450, 370-440, or 370-430° C.,

a pressure in the range of from 80-170, 80-160, 80-150, 90-170, 90-160, 90-150, 100-170, 100-160, or 100-150 bars,

a LHSV in the range of from 0.5-4, 0.5-2, or 0.5-1 h-1, and

a hydrogen gas feed rate (standard liters per liter of hydrocarbon feed, SLt/Lt) in the range of from 500-2500, 500-2000, 500-1500, 800-2500, 800-2000, 800-1500, 1000-2500, 1000-2000, or 1000-1500 L/L.

Effective catalyst for the inline hydrotreating zone 140 include catalysts that contain one or more active metal component of metals or metal compounds (oxides or sulfides) selected from the Periodic Table of the Elements IUPAC Groups 6, 7, 8, 9 and 10. One or more active metal component(s) are typically deposited or otherwise incorporated on a support, which can be amorphous and/or structured, such as alumina, silica alumina, silica, titania, titania-silica or titania-silicates. In certain embodiments, the active metal or metal compound is one or more of Co, Ni, W and Mo, including combinations such as one or more active metals or metal compounds selected from Co/Mo, Ni/Mo, Ni/W, and Co/Ni/Mo. Combinations of one or more of Co/Mo, Ni/Mo, Ni/W and Co/Ni/Mo, can also be used, for instance, in plural beds or separate reactors in series. The combinations can be composed of different particles containing a single active metal species, or particles containing multiple active species. In certain embodiments, the catalyst particles have a pore volume in the range of about (cc/gm) 0.15-1.70, 0.15-1.50, 0.30-1.50 or 0.30-1.70; a specific surface area in the range of about (m2/g) 100-400, 100-350, 100-300, 150-400, 150-350, 150-300, 200-400, 200-350 or 200-300; and an average pore diameter of at least about 10, 50, 100, 200, 500 or 1000 angstrom units. The active metal(s) or metal compound(s) are incorporated in an effective concentration, for instance, in the range of (wt % based on the mass of the oxides, sulfides or metals relative to the total mass of the catalysts) 1-40, 1-30, 1-10, 1-5, 2-40, 2-30, 2-10, 3-40, 3-30 or 3-10. Catalysts for the inline hydrotreating zone 140 are sometime referred to as a pretreating catalyst. In some embodiments, the catalyst for the inline hydrotreating zone 140 comprises Ni/Mo or Co/Mo as active metals and amorphous alumina as supporting material.

In certain embodiments, fluidized catalytic cracking zone 160 includes an FCC reactor operating under the following conditions:

a temperature in the range of from 450-700, 450-650, 450-620, 500-700, 500-650, 500-620, 530-700, 530-650, or 530-620° C.,

a pressure in the range of from 1-20, 1-10, or 1-3 bars,

a contact time (in the reactor) in the range of from 0.1-30, 0.1-10, 0.1-0.7, 0.2-30, 0.2-10, or 0.2-0.7 seconds, and

a catalyst to oil ratio on a mass basis in the range of from 1:1-60:1, 1:1-40:1, 1:1-20:1 or 1:1-6:1.

Effective catalyst for the fluidized catalytic cracking zone 160 includes catalysts such as zeolites, silica-alumina, carbon monoxide burning promoter additives, bottoms cracking additives, light olefin-producing additives and any other catalyst additives routinely used in the fluid catalytic cracking process. In certain embodiments, suitable cracking zeolites in the FCC process include zeolites Y, REY, USY, Beta and RE-USY. In certain embodiments, the suitable cracking zeolites used in the FCC process USY zeolite, including USY post and/or in-situ modified zeolite. For enhanced naphtha cracking potential, a preferred shaped selective catalyst additive can be employed, such as those used in fluid catalytic cracking processes to produce light olefins and increase fluid catalytic cracking gasoline octane is ZSM-5 zeolite crystal or other pentasil type catalyst structure. This ZSM-5 additive can be mixed with the cracking catalyst zeolites and matrix structures in conventional fluid catalytic cracking catalyst and is particularly suitable to maximize and optimize the cracking of the crude oil fractions in the downflow reaction zones. In certain embodiments, beta zeolite can be used as the catalyst additive.

In embodiments that utilize a steam cracking zone, such as stream cracking zone 210, the steam cracking zone operates as a high severity or a low severity thermal cracking process and converts the feedstock(s) into a mixed product stream containing mixed C₁-C₄ paraffins and olefins, pyrolysis gasoline and pyrolysis oil. In some embodiments, the first cracked/hydrotreated fraction 154 and the second cracked/hydrotreated fraction 156 are routed to stream cracking zone 210 for steam cracking to produce at least steam cracking gas effluents 212 and recovery of light olefins and aromatic products from the steam cracking gas effluents.

The steam cracking zone operates under parameters effective to crack the feed into desired products including hydrogen, methane, ethylene, propylene, and a mixed C4+ stream. Tar is also recovered. In certain embodiments, the steam cracking furnace(s) are operated at conditions effective to produce an effluent having a propylene-to-ethylene weight ratio of from about 0.3-0.8, 0.3-0.6, 0.4-0.8 or 0.4-0.6. The steam cracking zone generally comprises one or more trains of furnaces. For instance, a typical arrangement includes reactors that can operate based on well-known steam pyrolysis methods, that is, charging the thermal cracking feed to a convection section in the presence of steam to raise the temperature of the feedstock, and passing the heated feed to the pyrolysis reactor containing furnace tubes for cracking. In the convection section, the mixture is heated to a predetermined temperature, for example, using one or more waste heat streams or other suitable heating arrangement(s).

The steam cracking zone includes a convection section, a pyrolysis section, and a primary fractionator. A feed mixture and steam are heated to a high temperature in a convection section and material with a boiling point below a predetermined temperature is vaporized. The heated mixture (in certain embodiments along with additional steam) is passed to the pyrolysis section operating at a further elevated temperature for short residence times, such as 1-2 seconds or less, effectuating pyrolysis to produce a mixed product stream. Effluent from the cracking furnaces is typically quenched, for instance, using transfer line exchangers, and passed to a quench tower. Quenched gases are stripped with steam in the primary fractionator. In certain embodiments separate convection and radiant sections are used for different incoming feeds to the steam cracking zone with conditions in each optimized for the particular feed. Lighter gases are recovered as a product. The primary fractionator bottoms product is pyrolysis tar, which is cooled and can be sent to product storage. C4+ hydrocarbons from the primary fractionator are compressed, for instance, in one or two stages of compression, before entering an absorber and debutanizer.

In certain embodiments, steam cracking is carried out using the following conditions:

a temperature (° C.) in the convection section in the range of about 300-600, 300-550, 300-500, 300-450, 300-400, 400-600, 400-550, 400-500, 400-450, 450-600, 450-550, 450-500, or 500-600;

a pressure (barg) in the convection section in the range of about 4.3-9.7, 4.3-8.5, 4.3-7.7, 4.3-5, 4.5-9.7, 4.5-8.5, 4.5-7.7, 4.5-5, 7.2-9.7, 7.2-8.5, 7.2-7.7, 7.7-8.5, 7.7-9.7 or 8.5-9.7;

a temperature (C) in the pyrolysis section in the range of about 700-950, 700-900, 700-850, 750-950, 750-900 or 750-850;

a pressure (barg) in the pyrolysis section in the range of about 1-4, 1-2 or 1-1.4;

a steam-to-hydrocarbon ratio in the convection section in the range of about 0.3:1-2:1, 0.3:1-1.5:1, 0.5:1-2:1, 0.5:1-1.5:1, 0.7:1-2:1, 0.7:1-1.5:1, 1:1-2:1 or 1:1-1.5:1; and

a residence time (seconds) in the pyrolysis section in the range of about 0.05-1.2, 0.05-1, 0.1-1.2, 0.1-1, 0.2-1.2, 0.2-1, 0.5-1.2 or 0.5-1.

In operation of one embodiment of the steam cracking zone, the feedstocks are mixed with dilution steam to reduce hydrocarbon partial pressure and then are preheated. The preheated feeds are fed to tubular reactors mounted in the radiant sections of the cracking furnaces. The hydrocarbons undergo free-radical pyrolysis reactions to form light olefins ethylene and propylene, and other by-products. In certain embodiments, dedicated cracking furnaces are provided with cracking tube geometries optimized for each of the main feedstock types, including ethane, propane, and butanes/naphtha. Less valuable hydrocarbons, such as ethane, propane, C4 raffinate, and aromatics raffinate, produced within the integrated system and process, are recycled to extinction in the steam cracking zone.

In certain embodiments, cracked gas from the furnaces is cooled in transfer line exchangers (quench coolers), for example, producing 1800 psig steam suitable as dilution steam. A closed-loop dilution steam/process water system can be enabled, in which dilution steam is generated using heat recovery from the primary fractionator quench pumparound loops.

As used herein, the term “stream” (and variations of this term, such as hydrocarbon stream, feedstream, product stream, and the like) may include one or more of various hydrocarbon compounds, such as straight chain, branched or cyclical alkanes, alkenes, alkadienes, alkynes, alkylaromatics, alkenyl aromatics, condensed and non-condensed di-, tri- and tetra-aromatics, and gases such as hydrogen and methane, C2+ hydrocarbons and further may include various impurities.

The term “zone” refers to an area including one or more equipment, or one or more sub-zones. Equipment may include one or more reactors or reactor vessels, heaters, heat exchangers, pipes, pumps, compressors, and controllers. Additionally, an equipment, such as dryer, or vessels, further may be included in one or more zones.

The phrase “a major portion” with respect to a particular stream or plural streams means at least about 50 wt % and up to 100 wt %, or the same values of another specified unit.

The phrase “a significant portion” with respect to a particular stream or plural streams means at least about 75 wt % and up to 100 wt %, or the same values of another specified unit.

The phrase “a substantial portion” with respect to a particular stream or plural streams means at least about 90, 95, 98 or 99 wt % and up to 100 wt %, or the same values of another specified unit.

The phrase “a minor portion” with respect to a particular stream or plural streams means from about 1, 2, 4 or 10 wt %, up to about 20, 30, 40 or 50 wt %, or the same values of another specified unit.

The term “crude oil” as used herein refers to petroleum extracted from geologic formations in its unrefined form. Crude oil suitable as the source material for the processes herein include Arabian Heavy, Arabian Light, Arabian Extra Light, other Gulf crudes, Brent, North Sea crudes, North and West African crudes, Indonesian, Chinese crudes, North or South American crudes, Russian and Central Asian crudes, or mixtures thereof. The crude petroleum mixtures can be whole range crude oil or topped crude oil. As used herein, “crude oil” also refers to such mixtures that have undergone some pre-treatment such as water-oil separation; and/or gas-oil separation; and/or desalting; and/or stabilization. In certain embodiments, crude oil refers to any of such mixtures having an API gravity (ASTM D287 standard), of greater than or equal to about 10°, 20°, 30°, 32°, 34°, 36°, 38°, 40°, 42° or 44°.

The term “condensates” refers to hydrocarbons separated from natural gas stream. As used herein, “condensates” also refers to such mixtures that have undergone some pre-treatment such as water-oil separation; and/or gas-oil separation; and/or desalting; and/or stabilization. In certain embodiments, condensates refer to any of such mixtures having an API gravity (ASTM D287 standard), of greater than or equal to about 45, 50, 60, or 65°.

The acronym “LPG” as used herein refers to the well-known acronym for the term “liquefied petroleum gas,” and generally is a mixture of C3-C4 hydrocarbons. In certain embodiments, these are also referred to as “light ends.”

As used herein, all boiling point ranges relative to hydrocarbon fractions derived from crude oil via atmospheric and/or vacuum distillation shall refer to True Boiling Point values obtained from a crude oil assay, or a commercially acceptable equivalent.

The term “naphtha” as used herein refers to hydrocarbons having a nominal boiling range of about 20-205, 20-193, 20-190, 20-180, 20-170, 32-205, 32-193, 32-190, 32-180, 32-170, 36-205, 36-193, 36-190, 36-180 or 36-170° C.

The term “light naphtha” as used herein refers to hydrocarbons having a nominal boiling range of about 20-110, 20-100, 20-90, 20-88, 32-110, 32-100, 32-90, 32-88, 36-110, 36-100, 36-90 or 36-88° C.

The term “heavy naphtha” as used herein refers to hydrocarbons having a nominal boiling range of about 90-205, 90-193, 90-190, 90-180, 90-170, 93-205, 93-193, 93-190, 93-180, 93-170, 100-205, 100-193, 100-190, 100-180, 100-170, 110-205, 110-193, 110-190, 110-180 or 110-170° C.

In certain embodiments naphtha, light naphtha and/or heavy naphtha refer to such petroleum fractions obtained by crude oil distillation, or distillation of intermediate refinery processes as described herein.

The modifying term “straight run” is used herein having its well-known meaning, that is, describing fractions derived directly from the atmospheric distillation unit, optionally subjected to steam stripping, without other refinery treatment such as hydroprocessing, fluid catalytic cracking or steam cracking. An example of this is “straight run naphtha” and its acronym “SRN” which accordingly refers to “naphtha” defined above that is derived directly from the atmospheric distillation unit, optionally subjected to steam stripping, as is well known.

In certain embodiments, the term “middle distillate” is used with reference to one or more straight run fractions from the atmospheric distillation unit, for instance containing hydrocarbons having a nominal boiling range of about 160-400, 160-380, 160-370, 160-360, 160-340, 170-400, 170-380, 170-370, 170-360, 170-340, 180-400, 180-380, 180-370, 180-360, 180-340, 190-400, 190-380, 190-370, 190-360, 190-340, 193-400, 193-380, 193-370, 193-360, or 193-340° C. In embodiments in which other terminology is used herein, the middle distillate fraction can also include all or a portion of AGO range hydrocarbons, all or a portion of kerosene, all or a portion of medium AGO range hydrocarbons, and/or all or a portion of heavy kerosene range hydrocarbons. In additional embodiments, term “middle distillate” is used to refer to fractions from one or more integrated operations boiling in this range.

The term “atmospheric residue” and its acronym “AR” as used herein refer to the bottom hydrocarbons having an initial boiling point corresponding to the end point of the AGO or middle distillate range hydrocarbons, and having an end point based on the characteristics of the crude oil feed.

The term “vacuum gas oil” and its acronym “VGO” as used herein refer to hydrocarbons having a nominal boiling range of about 370-565, 370-550, 370-540, 370-530, 370-510, 400-565, 400-550, 400-540, 400-530, 400-510, 420-565, 420-550, 420-540, 420-530 or 420-510° C.

The term “vacuum residue” and its acronym “VR” as used herein refer to the bottom hydrocarbons having an initial boiling point corresponding to the end point of the VGO range hydrocarbons, and having an end point based on the characteristics of the crude oil feed.

The term “fuels” refers to crude oil-derived products used as energy carriers. Fuels commonly produced by oil refineries include, but are not limited to, gasoline, jet fuel, diesel fuel, fuel oil and petroleum coke. Unlike petrochemicals, which are a collection of well-defined compounds, fuels typically are complex mixtures of different hydrocarbon compounds.

The term “aromatic hydrocarbons” or “aromatics” is very well known in the art. Accordingly, the term “aromatic hydrocarbon” relates to cyclically conjugated hydrocarbons with a stability (due to delocalization) that is significantly greater than that of a hypothetical localized structure (for example, Kekule structure). “Aromatic hydrocarbons” or “aromatics” can refer to cyclically conjugated hydrocarbons having a single ring or multiple rings. A common method for determining aromaticity of a given hydrocarbon is the observation of diatropicity in its 1H NMR spectrum, for example the presence of chemical shifts in the range of from 7.2 to 7.3 ppm for benzene ring protons.

As used herein, the term “aromatic products” includes one or more of: C6-C8 aromatics including benzene, toluene and mixed xylenes (commonly referred to as BTX); C6-C8 aromatics including benzene, toluene, ethylbenzene and mixed xylenes (commonly referred to as BTEX), C6 and C8 aromatics including benzene and paraxylene; and any combination thereof. These aromatic products have a premium chemical value.

The term “unconverted oil” and its acronym “UCO,” is used herein having its known meaning, and refers to a highly paraffinic and naphthenic fraction from a hydrocracker with a low nitrogen, sulfur, vanadium and nickel content and including hydrocarbons having a nominal boiling range with an initial boiling point corresponding to the end point of the AGO range hydrocarbons, in certain embodiments the initial boiling point in the range of about 340-370° C., for instance about 340, 360 or 370° C., and an end point in the range of about 510-565° C., for instance about 540, 550 or 565° C. UCO is also known in the industry by other synonyms including “hydrowax.”

The term “C #hydrocarbons” or “C #”, is used herein having its well-known meaning, that is, wherein “#” is an integer value, and means hydrocarbons having that value of carbon atoms. The term “C #+ hydrocarbons” or “C #+” refers to hydrocarbons having that value or more carbon atoms. The term “C #-hydrocarbons” or “C #-” refers to hydrocarbons having that value or less carbon atoms. Similarly, ranges are also set forth, for instance, C₁-C₃ means a mixture comprising C1, C2 and C3.

The term “petrochemicals” or “petrochemical products” refers to chemical products derived from crude oil that are not used as fuels. Petrochemical products include olefins and aromatics that are used as a basic feedstock for producing chemicals and polymers. Typical olefinic petrochemical products include, but are not limited to, ethylene, propylene, butadiene, butylene-1, isobutylene, isoprene, cyclopentadiene and styrene. Typical aromatic petrochemical products include, but are not limited to, benzene, toluene, xylene, and ethyl benzene.

The term “olefin” is used herein having its well-known meaning, that is, unsaturated hydrocarbons containing at least one carbon-carbon double bond. In plural, the term “olefins” means a mixture comprising two or more unsaturated hydrocarbons containing at least one carbon-carbon double bond. In certain embodiments, the term “olefins” relates to a mixture comprising two or more of ethylene, propylene, butadiene, butylene-1, isobutylene, isoprene and cyclopentadiene. The term “light olefins” or “light olefin products” is used herein having its well-known meaning, that is: ethylene and propylene; or ethylene, propylene, butylene and butadiene.

The term “make-up hydrogen” is used herein with reference to hydroprocessing zones to refer to hydrogen requirements of the zone that exceed recycle from conventionally integrated separation vessels; in certain embodiments as used herein all or a portion of the make-up hydrogen in any given hydroprocessing zone or reactor within a zone is from gases derived from the petrochemical production operation(s) in the integrated processes and systems.

The term “light cycle oil” and its acronym “LCO” as used herein refers to the light cycle oil produced by FCC units. The nominal boiling range for this stream is, for example, in the range of about 215-350, 216-350, 220-350, 215-343, 216-343, 220-343, 215-330, 216-330 or 220-330° C. LCO, directly from FCC separation or after hydrotreating, is conventionally used in diesel blends depending on the diesel specifications, or as a cutter to the fuel oil tanks for a reduction in the viscosity and sulfur contents.

The term “heavy cycle oil” and its acronym “HCO” as used herein refer to the heavy cycle oil which is produced by fluid catalytic cracking units. The nominal boiling range for this stream is, for example, in the range of about 330-530, 330-510, 343-530, 343-510, 350-530 or 350-510° C. HCO is conventionally used in an oil flushing system within the process. Additionally, HCO is conventionally used to partially vaporize debutanizer bottoms and for recycle as a circulating reflux to the main fractionator in the fluid catalytic cracking unit.

The term “cycle oil” is used herein to refer to a mixture of LCO and HCO.

The term “slurry oil” is used herein to refer to the heaviest fraction which remain as a bottoms fraction after fluid catalytic cracking units. Slurry oil typically contains solid catalyst particles and/or fines. The hydrocarbon mixture of slurry oil is highly aromatic, high boiling, dense liquid. Slurry oil is conventionally used as fuel oil or can be processed (after removal of solid catalyst particles and/or fines).

### EXAMPLES

The below example and data are exemplary.

A crude oil was processed in a refinery according to FIG. 1 to produce chemicals. The properties and composition of crude oil is shown in Table 1.

TABLE 1

| Property/Composition | Unit | Value |
|---|---|---|
| API Gravity | ° | 27.4 |
| Sulfur | wt % | 2.8 |
| Nitrogen | wt % | 0.16 |
| Vanadium | ppmw | 57 |
| Nickel | ppmw | 16 |
| Light Naphtha (C5-100° C.) | wt % | 2.43 |
| Medium Naphtha (100-150° C.) | wt % | 5.24 |
| Heavy Naphtha (150-190° C.) | wt % | 5.06 |
| Light Kerosene (190-235° C.) | wt % | 6.35 |
| Heavy Kerosene (235-280° C.) | wt % | 6.72 |
| Atmospheric Gas Oil (280-343° C.) | wt % | 9.36 |
| Vacuum gas oil (343-565° C.) | wt % | 29.94 |
| Vacuum residue (565° C.+) | wt % | 29.65 |
| Atmospheric residue (343° C.+) | wt % | 59.58 |

Table 2 show the overall material balance for example process that is according to the embodiment shown in FIG. 1.

TABLE 2

| Stream | | Flow, | | |
|---|---|---|---|---|
| # | Stream Name | tons/day | Fuels | Chemicals |
| 102 | Crude Oil | 14,150 | | |
| 112 | LPG | 259 | 259 | |
| 114 | Naphtha | 2,153 | | |
| 116 | Distillates | 3,934 | | |
| 118 | Atmospheric Residue | 7,804 | | |
| 122 | VGO | 3,541 | | |
| 124 | Vacuum residue | 4,263 | | |
| 136 | Hydrogen | 226 | | |
| 132 | SPH effluents | 4,259 | | |
| 134 | Unconverted Effluents | 230 | 230 | |
| 142 | Hydrotreated SPH | 4,259 | | |
| | Effluents | | | |
| 152 | Gas | 1,055 | 1,055 | |
| 154 | Hydrotreated Naphtha | 757 | | |
| 156 | Hydrotreated Distillates | 6,465 | | |
| 158 | Hydrotreated VGO | 3,742 | | |
| 164 | C3 | 1,122 | | |
| 166 | C4 | 621 | | |
| 168¹ | Light Naphtha | 643 | | |
| 168¹ | Heavy Naphtha | 648 | | |
| 172 | LCO | 287 | | |
| 172′ | LCO to IL-HT | 287 | | |
| 174² | Heavy Cycle Oil/FCC | 209 | 209 | |
| | slurry oil | | | |
| 174² | Coke | 212 | | |
| 196 | Hydrogen | 138 | | 138 |
| 182 | Gas | 2,327 | 2,327 | 2,327 |
| 184 | Ethylene | 4,295 | | 4,295 |
| 186 | Propylene | 2,635 | | 2,635 |
| 188 | Butadiene's | 637 | | 637 |
| 192 | Benzene and paraxylene | 1,259 | | 1,259 |
| 194 | Tar | 1,262 | 1,262 | |

¹Light naphtha and heavy naphtha refer to separate streams corresponding to the third FCC fraction 168, described herein.
²Heavy cycle oil and FCC slurry oil refer to separate streams corresponding to the fifth FCC fraction 174, described herein.

The example process according to the embodiment in FIG. 1 produces 38.8 wt % fuels and 62.2 wt % chemicals.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A process for petrochemical production comprising:
processing a slurry-phase hydrocracking feed comprising residue stream and/or a deasphalted residue stream in a slurry-phase hydrocracking reaction zone to produce slurry-phase hydrocracking effluents by
dispersing an effective amount of catalyst in the slurry-phase hydrocracking feed as a reactant-catalyst dispersion,
passing an effective amount of a hydrogen-containing gas through the reactant-catalyst dispersion,
wherein hydrocarbons in the slurry-phase hydrocracking feed are cracked into free-radical hydrocarbons of reduced size and wherein the free-radical hydrocarbons are stabilized by hydrogen from the hydrogen-containing gas,
discharging at least a first stream of slurry-phase hydrocracking effluents including unreacted hydrogen and which is under hydrogen partial pressure, and a second stream of unconverted bottoms;
processing all, a substantial portion, a significant portion or a major portion of the slurry-phase hydrocracking effluents in an inline hydrotreating zone for hydrodesulfurization and/or hydrodenitrogenation to produce a hydrotreated effluent;
fractioning the hydrotreated effluent into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons;
processing all, a substantial portion, a significant portion or a major portion of the third cracked/hydrotreated fraction in a fluidized catalytic cracking zone for catalytic cracking to produce FCC effluents and separating the FCC effluents into at least
a light gas stream including hydrogen, C1 hydrocarbons and C2 hydrocarbons,
a first FCC fraction comprising C3 hydrocarbons,
a second FCC fraction comprising C4 hydrocarbons,
a third FCC fraction comprising FCC naphtha,
a fourth FCC fraction comprising light cycle oil,
and a fifth FCC fraction comprising heavy cycle oil and/or FCC slurry oil;
passing all, a substantial portion, a significant portion or a major portion of the fourth FCC fraction to the inline hydrotreating zone; and
processing all, a substantial portion, a significant portion or a major portion of each of the first cracked/hydrotreated fraction, the second cracked/hydrotreated fraction, the first FCC fraction and the third FCC fraction in a petrochemicals production complex to produce light olefins and aromatic products.

2. The process as in claim 1, further comprising:
separating a crude oil feedstream by atmospheric distillation into at least
a first ADU fraction comprising straight run naphtha,
a second ADU fraction comprising middle distillates, and
a third ADU fraction comprising atmospheric residue;
separating from the third ADU fraction, in a vacuum distillation unit (VDU), at least
a first VDU fraction comprising vacuum gas oil, and
a second VDU fraction comprising vacuum residue
wherein the slurry-phase hydrocracking feed processed in the slurry-phase hydrocracking reaction zone comprises all, a substantial portion, a significant portion or a major portion of the second VDU fraction;
passing
all, a substantial portion, a significant portion or a major portion of the second ADU fraction, and
all, a substantial portion, a significant portion or a major portion of the first VDU fraction,
to the inline hydrotreating zone for processing together with all or a portion of the slurry-phase hydrocracking effluents and all or a portion of the fourth FCC fraction; and
optionally processing all or a portion of the first ADU fraction, optionally subjected to a naphtha hydrotreating step, in the petrochemicals production complex.

3. The process as in claim 1, further comprising:
separating a crude oil feedstream by atmospheric distillation into at least
a first ADU fraction comprising straight run naphtha,
a second ADU fraction comprising middle distillates, and
a third ADU fraction comprising atmospheric residue,
wherein the slurry-phase hydrocracking feed processed in the slurry-phase hydrocracking reaction zone comprises all, a substantial portion, a significant portion or a major portion of the third ADU fraction;
passing all, a substantial portion, a significant portion or a major portion of the second ADU fraction to the inline hydrotreating zone for processing together with all or a portion of the slurry-phase hydrocracking effluents and all or a portion of the fourth FCC fraction; and
optionally processing all or a portion of the first ADU fraction, optionally subjected to a naphtha hydrotreating step, in the petrochemicals production complex.

4. The process as in claim 1, further comprising:
separating a crude oil feedstream by atmospheric distillation into at least
a first ADU fraction comprising straight run naphtha,
a second ADU fraction comprising middle distillates, and
a third ADU fraction comprising atmospheric residue;
separating from the third ADU fraction, in a vacuum distillation unit (VDU), at least
a first VDU fraction comprising vacuum gas oil, and
a second VDU fraction comprising vacuum residue;
subjecting all, a substantial portion, a significant portion or a major portion of the second VDU fraction to solvent deasphalting to produce a solvent deasphalted vacuum residue and asphalt, wherein the slurry-phase hydrocracking feed processed in the slurry-phase hydrocracking reaction zone comprises all, a substantial portion, a significant portion or a major portion of the solvent deasphalted vacuum residue;
and
passing
all, a substantial portion, a significant portion or a major portion of the second ADU fraction, and
all, a substantial portion, a significant portion or a major portion of the first VDU fraction,
to the inline hydrotreating zone for processing together with all or a portion of the slurry-phase hydrocracking effluents and all or a portion of the fourth FCC fraction; and
optionally processing all or a portion of the first ADU fraction, optionally subjected to a naphtha hydrotreating step, in the petrochemicals production complex.

5. The process as in claim 1, further comprising:
separating a crude oil feedstream by atmospheric distillation into at least
a first ADU fraction comprising straight run naphtha,
a second ADU fraction comprising middle distillates, and
a third ADU fraction comprising atmospheric residue;
subjecting all, a substantial portion, a significant portion or a major portion of the third ADU fraction to solvent deasphalting to produce a solvent deasphalted atmospheric residue and asphalt, wherein the slurry-phase hydrocracking feed processed in the slurry-phase hydrocracking reaction zone comprises all, a substantial portion, a significant portion or a major portion of the solvent deasphalted atmospheric residue;
and
passing all, a substantial portion, a significant portion or a major portion of the second ADU fraction to the inline hydrotreating zone for processing together with all or a portion of the slurry-phase hydrocracking effluents and all or a portion of the fourth FCC fraction; and
optionally processing all or a portion of the first ADU fraction, optionally subjected to a naphtha hydrotreating step, in the petrochemicals production complex.

6. The process as in claim 1, further comprising:
subjecting a crude oil feedstream to solvent deasphalting to produce a deasphalted crude oil stream and asphalt;
separating the deasphalted crude oil stream by atmospheric distillation into at least
a first ADU fraction comprising straight run naphtha,
a second ADU fraction comprising middle distillates, and
a third ADU fraction comprising atmospheric residue;
separating from the third ADU fraction, in a vacuum distillation unit (VDU), at least
a first VDU fraction comprising vacuum gas oil, and
a second VDU fraction comprising vacuum residue
wherein the slurry-phase hydrocracking feed processed in the slurry-phase hydrocracking reaction zone comprises all, a substantial portion, a significant portion or a major portion of the second VDU fraction;
and
passing
all, a substantial portion, a significant portion or a major portion of the second ADU fraction, and
all, a substantial portion, a significant portion or a major portion of the first VDU fraction,
to the inline hydrotreating zone for processing together with all or a portion of the slurry-phase hydrocracking effluents and all or a portion of the fourth FCC fraction; and
optionally processing all or a portion of the first ADU fraction, optionally subjected to a naphtha hydrotreating step, in the petrochemicals production complex.

7. The process as in claim 1, further comprising:
subjecting a crude oil feedstream to solvent deasphalting to produce a deasphalted crude oil stream and asphalt;
separating the deasphalted crude oil stream by atmospheric distillation into at least
a first ADU fraction comprising straight run naphtha,
a second ADU fraction comprising middle distillates, and
a third ADU fraction comprising atmospheric residue,
wherein the slurry-phase hydrocracking feed processed in the slurry-phase hydrocracking reaction zone comprises all, a substantial portion, a significant portion or a major portion of the third ADU fraction;
and
passing all, a substantial portion, a significant portion or a major portion of the second ADU fraction to the inline hydrotreating zone for processing together with all or a portion of the slurry-phase hydrocracking effluents and all or a portion of the fourth FCC fraction; and
optionally processing all or a portion of the first ADU fraction, optionally subjected to a naphtha hydrotreating step, in the petrochemicals production complex.

8. The process of claim 1, wherein processing in the petrochemicals production complex comprises subjecting the first cracked/hydrotreated fraction and the second cracked/hydrotreated fraction, to steam cracking to produce at least steam cracking gas effluents and recovery of light olefins and aromatic products from the steam cracking gas effluents.

9. The process of claim 2, wherein processing in the petrochemicals production complex comprises subjecting the first cracked/hydrotreated fraction, the second cracked/hydrotreated fraction, and all or a portion of the first ADU fraction to steam cracking to produce at least steam cracking gas effluents and recovery of light olefins and aromatic products from the steam cracking gas effluents.

10. The process of claim 8, wherein recovery of light olefins and aromatic products from the steam cracking gas effluents comprises:
subjecting the steam cracking gas effluents and the first FCC fraction to compression to separate at least hydrogen, methane, ethylene, propylene and a stream of mixed C4+ hydrocarbons,
debutanizing the mixed C4+ hydrocarbons and the second FCC fraction to separate mixed C4 hydrocarbons and mixed C5+ hydrocarbons;
optionally hydrogenating the mixed C4 hydrocarbons to produce hydrogenated mixed C4 hydrocarbons;
extracting butadiene from the mixed C4 hydrocarbons or the optionally hydrogenated mixed C4 hydrocarbons;
separating aromatic products from the mixed C5+ hydrocarbons and the third FCC fraction.

11. The process of claim 8, wherein the third FCC fraction comprises diolefins and/or monoolefins and is hydrotreated before the separation step.

12. The process of claim 4, wherein all or a portion of the second stream of unconverted effluent from a portion of the second stream of unconverted bottoms from processing in the slurry-phase hydrocracking reaction zone is passed to solvent deasphalting.

13. The process as in claim 1, further wherein one or more of the first cracked/hydrotreated fraction, the second cracked/hydrotreated fraction, the first FCC fraction and the third FCC fraction are optionally subjected to a naphtha hydrotreating step.

14. The process as in claim 1, wherein the fifth FCC fraction comprises heavy cycle oil which is passed to a fuel oil pool or the fifth FCC fraction comprises FCC slurry oil which is passed to the inline hydrotreating zone after removal of solid FCC catalyst.

15.-19. (canceled)

20. The process of claim 1, wherein the catalyst for processing in the slurry-phase hydrocracking reaction zone comprises one or more transition metal complexes, precursors, or ligands, including one or more of Mo, W, Ni, Co, Fe, Ru or Cr.

21. The process of claim 1, wherein the catalyst for processing in the slurry-phase hydrocracking reaction zone comprises one or more heterogeneous support particles, wherein the support particles are one or more of iron, coal, activated carbon, alumina, or silica-alumina.

22.-23. (canceled)

24. The process as in claim 21, wherein the catalyst for processing in the slurry-phase hydrocracking reaction zone comprises a transition metal complex and an aromatic bottoms comprising C9 aromatics, C10 aromatics, C11 aromatics, C11+ aromatics, or a combination thereof, wherein the transition metal complex is dissolved or dispersed in the aromatic bottoms, wherein the transition metal complex comprises ligands, organometallics, salts, oxides, sulfides, or a combination thereof.

25.-27. (canceled)

28. The process of claim 1, wherein the catalyst for processing in the slurry-phase hydrocracking reaction zone comprises a transition metal complex, and a disulfide oil, wherein the disulfide oil is a reaction product of a mercaptan oxidation reaction, the metal complex is dissolved in the disulfide oil to form a mixed catalyst composition, and at least a portion of the mixed catalyst composition is transferred to a slurry-phase hydrocracking unit to form the catalyst for processing in the slurry-phase hydrocracking reaction zone.

29.-40. (canceled)

41. A process for petrochemical production comprising:
separating a crude oil feedstream by atmospheric distillation into at least
a first ADU fraction comprising straight run naphtha,
a second ADU fraction comprising middle distillates, and
a third ADU fraction comprising atmospheric residue;
separating from the third ADU fraction, in a vacuum distillation unit (VDU), at least
a first VDU fraction comprising vacuum gas oil, and
a second VDU fraction comprising vacuum residue;
subjecting all, a substantial portion, a significant portion or a major portion of the second VDU fraction to solvent deasphalting to produce a solvent deasphalted vacuum residue and asphalt;
processing a slurry-phase hydrocracking feed comprising the solvent deasphalted vacuum residue in a slurry-phase hydrocracking reaction zone to produce slurry-phase hydrocracking effluents by
dispersing an effective amount of catalyst in the slurry-phase hydrocracking feed as a reactant-catalyst dispersion,
passing an effective amount of a hydrogen-containing gas through the reactant-catalyst dispersion,
wherein hydrocarbons in the slurry-phase hydrocracking feed are cracked into free-radical hydrocarbons of reduced size and wherein the free-radical hydrocarbons are stabilized by hydrogen from the hydrogen-containing gas,
discharging at least a first stream of slurry-phase hydrocracking effluents including unreacted hydrogen and which is under hydrogen partial pressure, and a second stream of unconverted bottoms;
processing all, a substantial portion, a significant portion or a major portion of the slurry-phase hydrocracking effluents, the second ADU fraction, and the first VDU fraction, in an inline hydrotreating zone for hydrodesulfurization and/or hydrodenitrogenation to produce a hydrotreated effluent;
fractioning the hydrotreated effluent into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons;
processing all, a substantial portion, a significant portion or a major portion of the third cracked/hydrotreated fraction in a fluidized catalytic cracking zone for catalytic cracking to produce FCC effluents and separating the FCC effluents into at least
a light gas stream including hydrogen, C1 hydrocarbons and C2 hydrocarbons,
a first FCC fraction comprising C3 hydrocarbons,
a second FCC fraction comprising C4 hydrocarbons,
a third FCC fraction comprising FCC naphtha,
a fourth FCC fraction comprising light cycle oil,
and a fifth FCC fraction comprising heavy cycle oil and/or FCC slurry oil;
passing all, a substantial portion, a significant portion or a major portion of the fourth FCC fraction to the inline hydrotreating zone;
and
processing all, a substantial portion, a significant portion or a major portion of each of the first cracked/hydrotreated fraction, the second cracked/hydrotreated fraction, the first FCC fraction, the third FCC fraction, and the first ADU fraction in a petrochemicals production complex to produce light olefins and aromatic products.

42. A process for petrochemical production comprising:
separating a crude oil feedstream by atmospheric distillation into at least
a first ADU fraction comprising straight run naphtha,
a second ADU fraction comprising middle distillates, and
a third ADU fraction comprising atmospheric residue;
subjecting all, a substantial portion, a significant portion or a major portion of the third ADU fraction to solvent deasphalting to produce a solvent deasphalted atmospheric residue and asphalt;
processing a slurry-phase hydrocracking feed comprising the solvent deasphalted atmospheric residue in a slurry-phase hydrocracking reaction zone to produce slurry-phase hydrocracking effluents by
dispersing an effective amount of catalyst in the slurry-phase hydrocracking feed as a reactant-catalyst dispersion,
passing an effective amount of a hydrogen-containing gas through the reactant-catalyst dispersion,
wherein hydrocarbons in the slurry-phase hydrocracking feed are cracked into free-radical hydrocarbons of reduced size and wherein the free-radical hydrocarbons are stabilized by hydrogen from the hydrogen-containing gas,
discharging at least a first stream of slurry-phase hydrocracking effluents including unreacted hydrogen and which is under hydrogen partial pressure, and a second stream of unconverted bottoms;
processing all, a substantial portion, a significant portion or a major portion of the slurry-phase hydrocracking effluents and the second ADU fraction in an inline hydrotreating zone for hydrodesulfurization and/or hydrodenitrogenation to produce a hydrotreated effluent;
fractioning the hydrotreated effluent into a first cracked/hydrotreated fraction comprising naphtha-range hydrocarbons, a second cracked/hydrotreated fraction comprising middle distillate-range hydrocarbons and a third cracked/hydrotreated fraction comprising vacuum gas oil-range hydrocarbons;
processing all, a substantial portion, a significant portion or a major portion of the third cracked/hydrotreated fraction in a fluidized catalytic cracking zone for catalytic cracking to produce FCC effluents and separating the FCC effluents into at least
a light gas stream including hydrogen, C1 hydrocarbons and C2 hydrocarbons,
a first FCC fraction comprising C3 hydrocarbons,
a second FCC fraction comprising C4 hydrocarbons,
a third FCC fraction comprising FCC naphtha,
a fourth FCC fraction comprising light cycle oil,
and a fifth FCC fraction comprising heavy cycle oil and/or FCC slurry oil;
passing all, a substantial portion, a significant portion or a major portion of the fourth FCC fraction to the inline hydrotreating zone; and
processing all, a substantial portion, a significant portion or a major portion of each of the first cracked/hydrotreated fraction, the second cracked/hydrotreated fraction, the first FCC fraction, the third FCC fraction, and the first ADU fraction in a petrochemicals production complex to produce light olefins and aromatic products.
